(19) United States
(12) Patent Application Publication
(10) Pub. No.: US 2019/0180154 A1
(43) Pub. Date: Jun. 13, 2019

(54) TEXT RECOGNITION USING ARTIFICIAL INTELLIGENCE

(71) Applicant: ABBYY Development LLC, Moscow (RU)

(72) Inventors: Nikita Orlov, Chelyabinsk (RU); Vladimir Rybkin, Moscow (RU); Konstantin Anisimovich, Moscow (RU); Azat Davletshin, Naberezhnye Chelny (RU)

(21) Appl. No.: 15/849,488

(22) Filed: Dec. 20, 2017

(30) Foreign Application Priority Data
Dec. 13, 2017 (RU) 2017143592

(51) Int. Cl. G06K 9/72; G06K 9/34; G06K 9/00; G06K 9/62; G06F 17/22; G06N 3/04; G06N 3/08; G06F 15/18

(52) U.S. Cl. CPC G06K 9/72; G06K 9/344; G06K 9/00456; G06K 9/6256; G06K 2209/01; G06F 17/2217; G06N 3/04; G06N 3/08; G06F 15/18; G06K 9/6218

(57) ABSTRACT

A method includes obtaining an image of text. The text in the image includes one or more words in one or more sentences. The method also includes providing the image of the text as first input to a set of trained machine learning models, obtaining one or more final outputs from the set of trained machine learning models, and extracting, from the one or more final outputs, one or more predicted sentences from the text in the image. Each of the one or more predicted sentences includes a probable sequence of words.

### TECHNICAL FIELD

The present disclosure is generally related to computer systems, and is more specifically related to systems and methods for recognizing characters using artificial intelligence.

### BACKGROUND

Optical character recognition (OCR) techniques may be used to recognize texts in various languages. For example, an image of a document including text (e.g., printed or handwritten) may be obtained by scanning the document. Some OCR techniques may explicitly divide the text in the image into individual characters and apply recognition operations to each text symbol separately. This approach may introduce errors when applied to text in languages that include merged letters. Additionally, some OCR techniques may use a dictionary lookup when verifying recognized words in text. Such a technique may provide a high confidence indicator for a word that is found in the dictionary even if the word is nonsensical when read in the sentence of the text.

### SUMMARY OF THE DISCLOSURE

In one implementation, a method includes obtaining an image of text. The text in the image includes one or more words in one or more sentences. The method also includes providing the image of the text as first input to a set of trained machine learning models, obtaining one or more final outputs from the set of trained machine learning models, and extracting, from the one or more final outputs, one or more predicted sentences from the text in the image. Each of the one or more predicted sentences includes a probable sequence of words.

In another implementation, a method for training a set of machine learning models to identify a probable sequence of words for each of one or more sentences in an image of text. The method includes generating training data for the set of machine learning models. Generating the training data includes generating positive examples including first texts and generating negative examples including second texts and error distribution. The second texts include alterations that simulate at least one recognition error of one or more characters, one or more sequence of characters, or one or more sequence of words. The method also includes generating an input training set including the positive examples and the negative examples, and generating target outputs for the input training set. The target outputs identify one or more predicted sentences. Each of the one or more predicted sentences includes a probable sequence of words. The method providing the training data to train the set of machine learning models on (i) the input training set and (ii) the target outputs.

### BRIEF DESCRIPTION OF THE DRAWINGS

The present disclosure is illustrated by way of example, and not by way of limitation, and can be more fully understood with reference to the following detailed description when considered in connection with the figures in which:

FIG. 1 depicts a high-level component diagram of an illustrative system architecture, in accordance with one or more aspects of the present disclosure.

FIG. 2 depicts an example of a cluster, in accordance with one or more aspects of the present disclosure.

FIG. 3A depicts an example of normalization of a text line to a uniform height during preprocessing, in accordance with one or more aspects of the present disclosure.

FIG. 3B depicts an example of dividing a text line into fragments during preprocessing, in accordance with one or more aspects of the present disclosure.

FIG. 4 depicts a flow diagram of an example method for training one or more machine learning models, in accordance with one or more aspects of the present disclosure.

FIG. 5 depicts an example training set used to train one or more machine learning models, in accordance with one or more aspects of the present disclosure.

FIG. 6 depicts a flow diagram of an example method for using one or more machine learning models to recognize text from an image, in accordance with one or more aspects of the present disclosure.

FIG. 7 depicts example modules of the character recognition engine that recognize one or more sequences of characters for each word in the text, in accordance with one or more aspects of the present disclosure.

FIG. 8A depicts an example of extracting features in each position in the image using the cluster encoder, in accordance with one or more aspects of the present disclosure.

FIG. 8B depicts an example of a word with division points a cluster identified, in accordance with one or more aspects of the present disclosure.

FIG. 9 depicts an example of an architecture for a convolutional neural network used by the encoders, in accordance with one or more aspects of the present disclosure.

FIG. 10 depicts an example of applying the convolutional neural network to an image to detect characteristics of the image using filters, in accordance with one or more aspects of the present disclosure.

FIG. 11 depicts an example recurrent neural network used by the encoders, in accordance with one or more aspects of the present disclosure.

FIG. 12 depicts an example of an architecture for a recurrent neural network used by the encoders, in accordance with one or more aspects of the present disclosure.

FIG. 13 depicts an example of an architecture for a fully connected neural network used by the encoders, in accordance with one or more aspects of the present disclosure.

FIG. 14 depicts a flow diagram of an example method for using a decoder to determine sequences of characters for words in an image, in accordance with one or more aspects of the present disclosure.

FIG. 15 depicts a flow diagram of an example method for using a character machine learning model to determine the most probable sequence of characters in the context of the words, in accordance with one or more aspects of the present disclosure.

FIG. 16 depicts an example of using the character machine learning model described with reference to the method in FIG. 15, in accordance with one or more aspects of the present disclosure.

FIG. 17 depicts a flow diagram of another example method for using a character machine learning model to determine the most probable sequence of characters in the context of the words, in accordance with one or more aspects of the present disclosure.

FIG. 18 depicts an example of using the character machine learning model described with reference to the method in FIG. 17, in accordance with one or more aspects of the present disclosure.

FIG. 19 depicts an example of the character machine learning model implemented as a recurrent neural network, in accordance with one or more aspects of the present disclosure.

FIG. 20 depicts an example architecture of the character machine learning model implemented as a convolutional neural network, in accordance with one or more aspects of the present disclosure.

FIG. 21 depicts a flow diagram of an example method for using a word machine learning model to determine the most probable sequence of words in the context of the sentences, in accordance with one or more aspects of the present disclosure.

FIG. 22 depicts an example of using the word machine learning model described with reference to the method in FIG. 21, in accordance with one or more aspects of the present disclosure.

FIG. 23 depicts a flow diagram of another example method for using a word machine learning model to determine the most probable sequence of words in the context of sentences, in accordance with one or more aspects of the present disclosure.

FIG. 24 depicts an example architecture of the word machine learning model implemented as a combination of a recurrent neural network and a convolutional neural network, in accordance with one or more aspects of the present disclosure.

FIG. 25 depicts an example computer system which can perform any one or more of the methods described herein, in accordance with one or more aspects of the present disclosure.

### DETAILED DESCRIPTION

In some instances, conventional character recognition techniques may explicitly divide text into individual characters and apply recognition operations to each character separately. These techniques are poorly suited for recognizing merged letters, such as those used in Arabic script, Farsi, handwritten text, and so forth. For example, errors may be introduced when dividing the word into its individual characters, which may introduce further errors in a subsequent stage of character-by-character recognition.

Additionally, conventional character recognition techniques may verify a recognized word from text by consulting a dictionary. For example, a recognized word may be determined for a particular text, and the recognized word may be searched in a dictionary. If the searched word is found in the dictionary, then the recognized word is assigned a high numerical indicator of “confidence.” From the possible variants of recognized words, the word having the highest confidence may be selected.

To illustrate, as a result of recognition, five variants of words may be recognized using a conventional character recognition technique: “ail,” “all,” “Oil,” “aM,” “oil.” When evaluating these options for the dictionary words: “ail”, “Oil” (the first character is a zero), and “aM” may receive low confidence indicators using conventional techniques because the words may not be found in a certain dictionary. Those words may not be returned as recognition results. On the other hand, the words “all” and “oil” may pass the dictionary check and may be presented with a high degree of confidence as recognition results by the conventional technique. However, the conventional technique may not account for the characters in the context of a word or the words in the context of a sentence. As such, the recognition results may be erroneous or highly inaccurate.

Embodiments of the present disclosure address these issues by using a set of machine learning models (e.g., neural networks) to effectively recognize text. In particular, some embodiments do not explicitly divide text into characters. Instead, some embodiments apply the set of neural networks for the simultaneous determination of division points between symbols in words and recognition of the symbols. The set of machine learning models may be trained on a body of texts. In some embodiments, the set of machine learning models may store information about the compatibility of words and the frequency of their joint use in real sentences as well as the compatibility of characters and the frequency of their joint use in real words.

The term “character,” “symbol,” “letter,” and “cluster” may be used interchangeably herein. A cluster may refer to an elementary indivisible graphic element (e.g., graphemes and ligatures), which are united by a common logical value. Further, the term “word” may refer to a sequence of symbols, and the term “sentence” may refer to a sequence of words.

Once trained, the set of machine learning models may be used for recognition of characters, character-by-character analysis to select the most probable characters in the context of a word, and word-by-word analysis to select the most probable words in the context of a sentence. That is, some embodiments may enable using the set of machine learning models to determine the most probable result of character recognition in the context of a word and a word in the context of a sentence. For example, an image of text may be input to the set of trained machine learning models to obtain one or more final outputs. One or more predicted sentences may be extracted from the text in the image. Each of the predicted sentences may include a probable sequence of words and each of the words may include a probable sequence of characters.

As a final result of the recognition techniques disclosed herein, predicted sentences having the most probable sequence of words may be selected for display. Continuing the example with the selected words, “all” and “oil,” above, inputting the selected words into the one or more machine learning models disclosed herein may consider the words in the context of a sentence (e.g., “These instructions apply to (‘all’ or ‘oil’) tAAs submitted by customers”) and select “all” as the recognized word because it fits the sentence better in relation to the other words in the sentence than “oil” does. Using the set of machine learning models may improve the quality of recognition results for texts including merged and/or unmerged characters and by taking into account the context of other characters in a word and other words in a sentence. The embodiments may be applied to images of both printed text and handwritten text in any suitable language. Further, the particular machine learning models (e.g., convolutional neural networks) that are used may be particularly well-suited for efficient text recognition and may improve processing speed of a computing device.

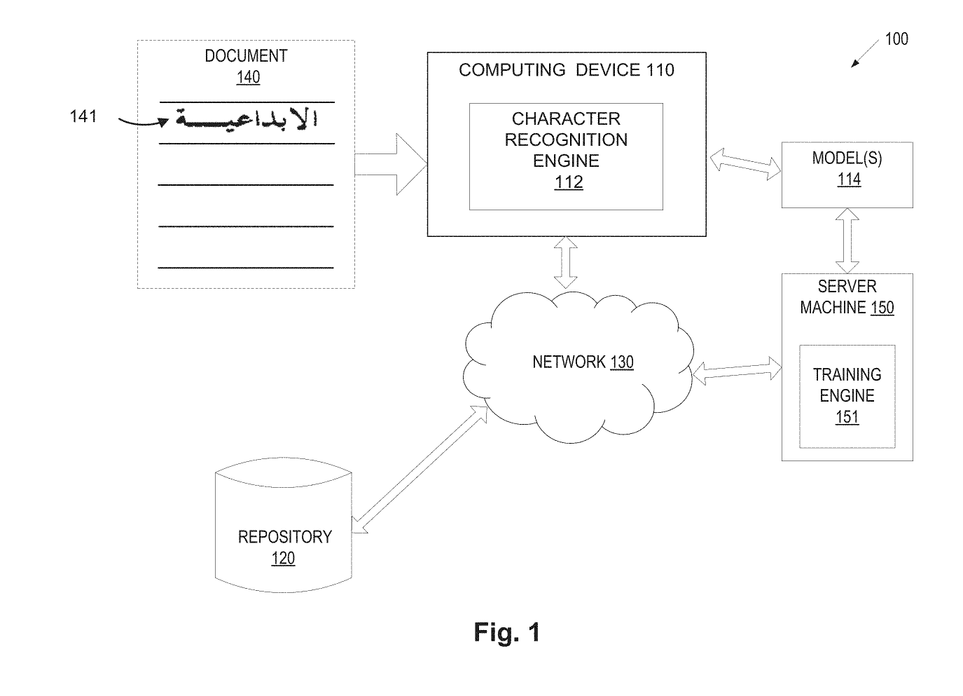

FIG. 1 depicts a high-level component diagram of an illustrative system architecture 100, in accordance with one or more aspects of the present disclosure. System architecture 100 includes a computing device 110, a repository 120, and a server machine 150 connected to a network 130. Network 130 may be a public network (e.g., the Internet), a private network (e.g., a local area network (LAN) or wide area network (WAN)), or a combination thereof.

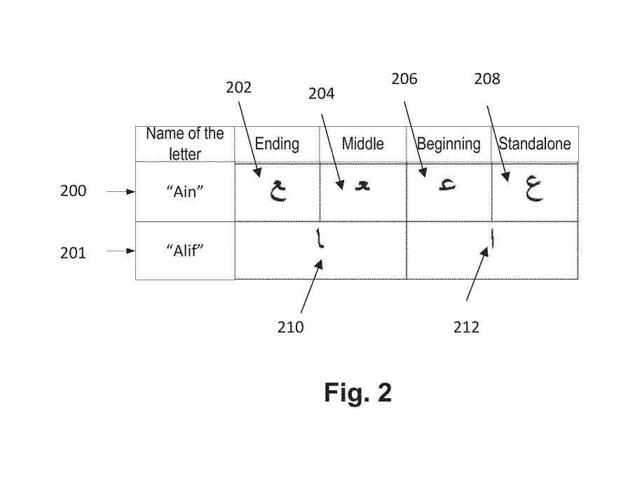

The computing device 110 may perform character recognition using artificial intelligence to effectively recognize texts including one or more sentences. The recognized sentences may each include one or more words. The recognized words may each include one or more characters (e.g. clusters). FIG. 2 depicts an example of two clusters 200 and 201. As noted above, a cluster may be an elementary indivisible graphic element that is united by a common logical value with other clusters. In some languages, including Arabic, the same letter has a different way of being written depending on its position (e.g., in the beginning, in the middle, at the end and apart) in the word.

For example, as depicted, the name of the letter “Ain” is written as a first graphic element 202 (e.g., cluster) when positioned at the end of a word, a second graphic element 204 when positioned in the middle of the word, a third graphic element 206 when positioned at the beginning of the word, and a fourth graphic element 208 when positioned alone. Additionally, the name of the letter “Alif” is written as a first graphic element 210 when positioned in the ending or middle of the word and a second graphic element 212 when positioned in the beginning of the word or alone. Accordingly, for recognition, some embodiments may take into account the position of the letter in the word, for example, by combining different variants of writing the same letter in different positions in the word such that the possible graphic elements of the letter for each position are evaluated.

Returning to FIG. 1, the computing device 110 may be a desktop computer, a laptop computer, a smartphone, a tablet computer, a server, a scanner, or any suitable computing device capable of performing the techniques described herein. A document 140 including text written in Arabic script may be received by the computing device 110. It should be noted that text printed or handwritten in any language may be received. The document 140 may include one or more sentences each having one or more words that each has one or more characters.

The document 140 may be received in any suitable manner. For example, the computing device 110 may receive a digital copy of the document 140 by scanning the document 140 or photographing the document 140. Thus, an image 141 of the text including the sentences, words, and characters included in the document 140 may be obtained. Additionally, in instances where the computing device 110 is a server, a client device connected to the server via the network 130 may upload a digital copy of the document 140 to the server. In instances where the computing device 110 is a client device connected to a server via the network 130, the client device may download the document 140 from the server.

The image of text 141 may be used to train a set of machine learning models or may be a new document for which recognition is desired. Accordingly, in the preliminary stages of processing, the image 141 of text included in the document 140 can be prepared for training the set of machine learning models or subsequent recognition. For instance, in the image 141 of the text, text lines may be manually or automatically selected, characters may be marked, text lines may be normalized, scaled and/or binarized.

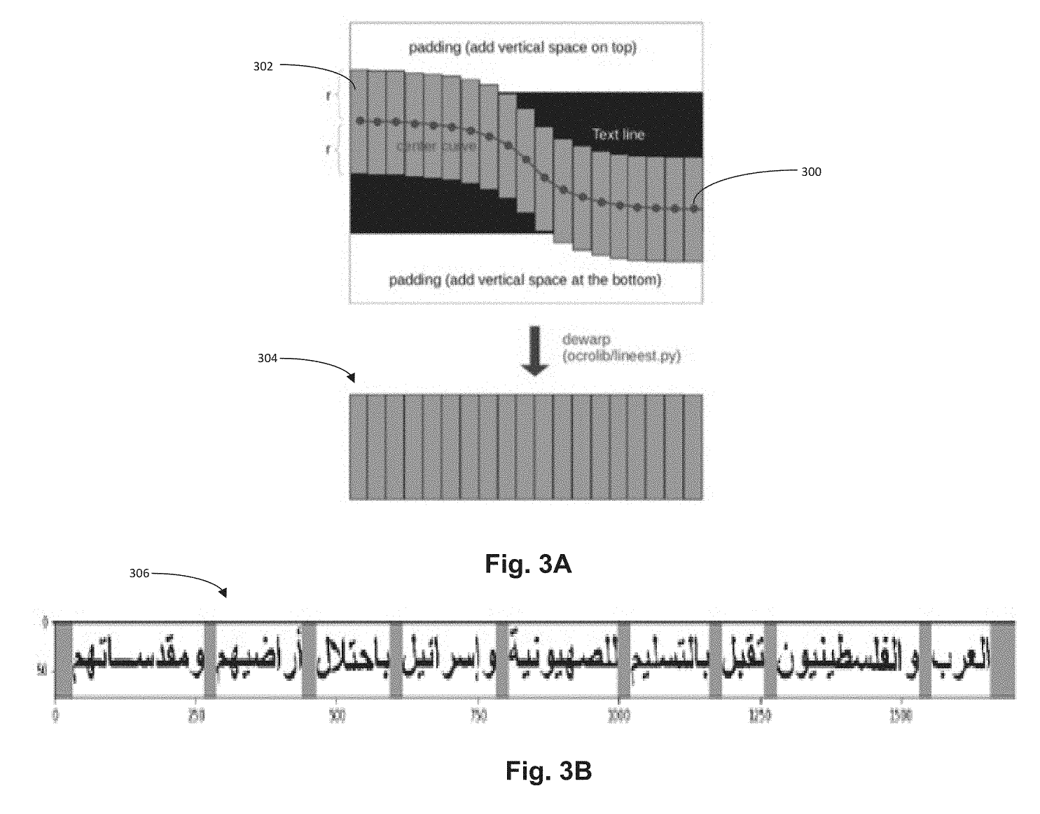

Normalization may be performed before training the set of machine learning models and/or before recognition of text in the image 141 to bring every line of text to a uniform height (e.g., 80 pixels). FIG. 3A depicts an example of normalization of a text line to a uniform height during preprocessing, in accordance with one or more aspects of the present disclosure. First, a center 300 of text may be found on an intensity maxima (the largest accumulation of dark dots on a binarized image). A height 302 of the text may be calculated from the center 300 by the average deviation of the dark pixels from the center 300. Further, columns of fixed height are obtained by adding indents (padding) of vertical space on top and bottom of the text. A dewarped image 304 may be obtained as a result. The dewarped image 304 may then be scaled.

Additionally, during preprocessing, the text in the image 141 obtained from the document 140 may be divided into fragments of text, as depicted in FIG. 3B. As depicted, a line is divided into fragments of text automatically on gaps having a certain color (e.g., white) that are more than threshold amount (e.g., 10) of pixels wide. Selecting text lines in an image of text may enhance processing speed when recognizing the text by processing shorter lines of text concurrently, for example, instead of one long line of text. The preprocessed and calibrated images 141 of the text may be used to train a set of machine learning models or may be provided as input to a set of trained machine learning models to determine the most probable text.

Returning to FIG. 1, the computing device 110 may include a character recognition engine 112. The character recognition engine 112 may include instructions stored on one or more tangible, machine-readable media of the computing device 110 and executable by one or more processing devices of the computing device 110. In an implementation, the character recognition engine 112 may use a set of trained machine learning models 114 that are trained and used to predict sentences from the text in the image 141. The character recognition engine 112 may also preprocess any received images prior to using the images for training of the set of machine learning models 114 and/or applying the set of trained machine learning models 114 to the images. In some instances, the set of trained machine learning models 114 may be part of the character recognition engine 112 or may be accessed on another machine (e.g., server machine 150) by the character recognition engine 112. Based on the output of the set of trained machine learning models 114, the character recognition engine 112 may extract one or more predicted sentences from text in the image 141.

Server machine 150 may be a rackmount server, a router computer, a personal computer, a portable digital assistant, a mobile phone, a laptop computer, a tablet computer, a camera, a video camera, a netbook, a desktop computer, a media center, or any combination of the above. The server machine 150 may include a training engine 151. The set of machine learning models 114 may refer to model artifacts that are created by the training engine 151 using the training data that includes training inputs and corresponding target outputs (correct answers for respective training inputs). The training engine 151 may find patterns in the training data that map the training input to the target output (the answer to be predicted), and provide the machine learning models 114 that capture these patterns. As described in more detail below, the set of machine learning models 114 may be composed of, e.g., a single level of linear or non-linear operations (e.g., a support vector machine [SVM]) or may be a deep network, i.e., a machine learning model that is composed of multiple levels of non-linear operations. Examples of deep networks are neural networks including convolutional neural networks, recurrent neural networks with one or more hidden layers, and fully connected neural networks.

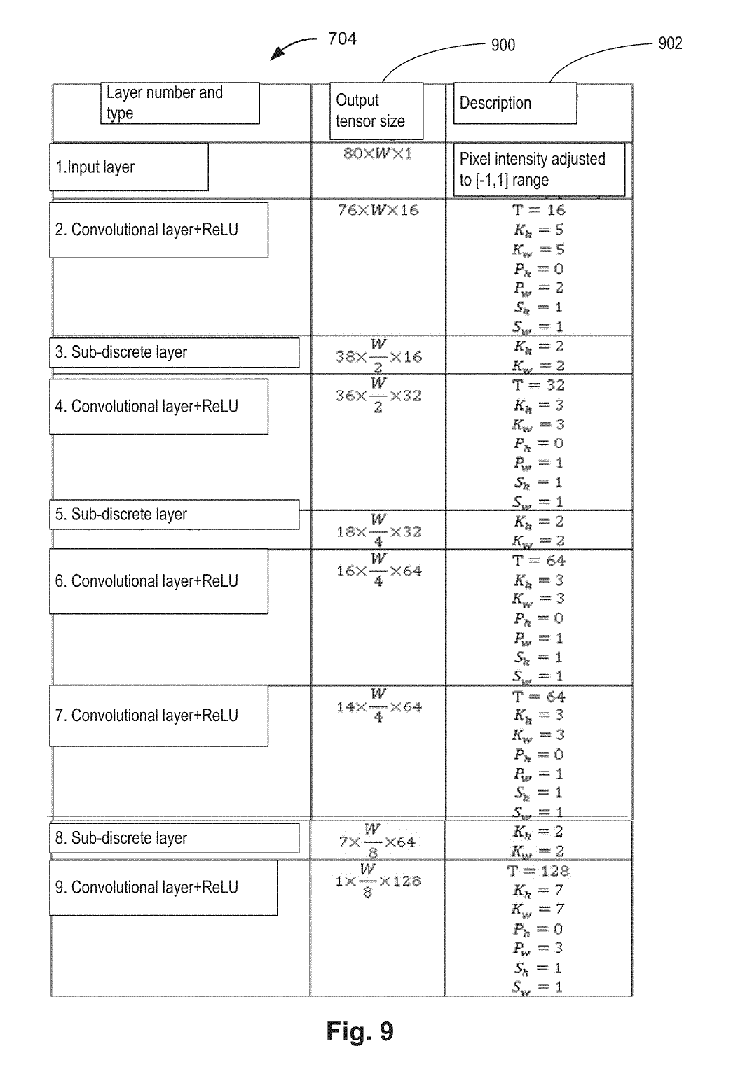

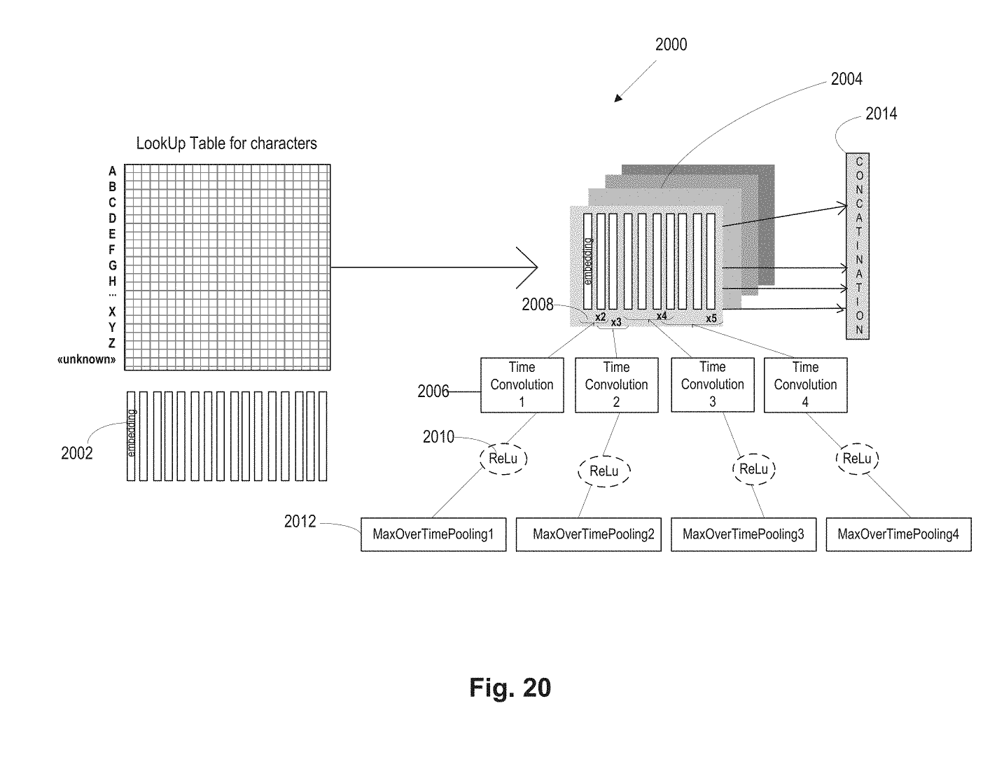

Convolutional neural networks include architectures that may provide efficient image recognition. Convolutional neural networks may include several convolutional layers and subsampling layers that apply filters to portions of the image of the text to detect certain features. That is, a convolutional neural network includes a convolution operation, which multiplies each image fragment by filters (e.g., matrices) element-by-element and sums the results in a similar position in an output image (example architectures shown in FIGS. 9 and 20).

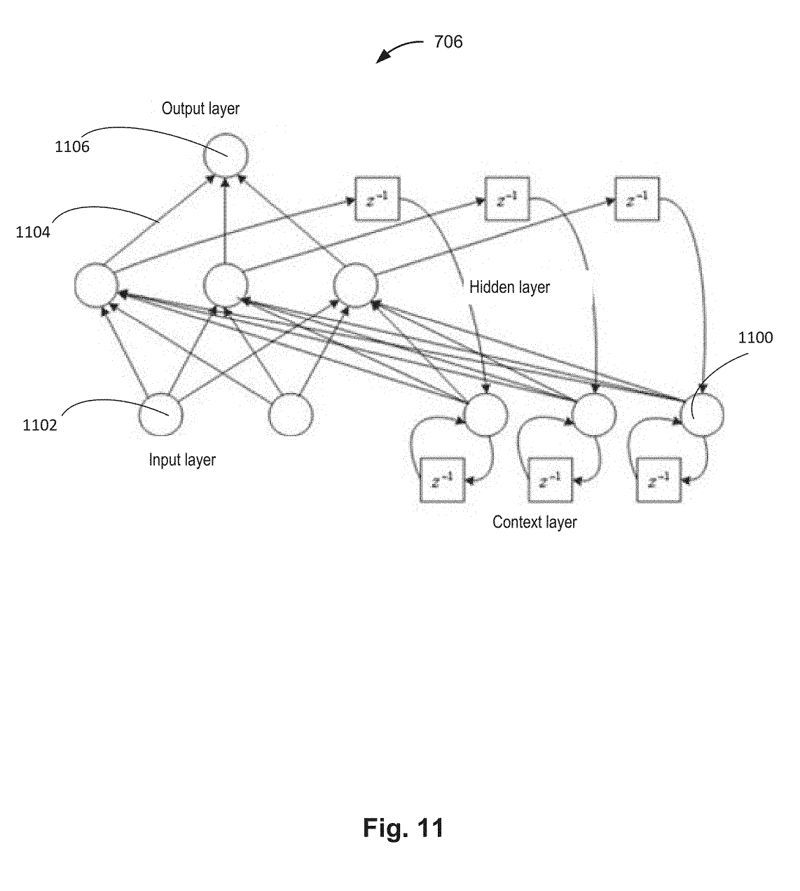

Recurrent neural networks include the functionality to process information sequences and store information about previous computations in the context of a hidden layer. As such, recurrent neural networks may have a “memory” (example architectures shown in FIGS. 11, 12 and 19). Keeping and analyzing information about previous and subsequent positions in a sequence of characters in a word enhances character recognition of merged letters, since the character width may exceed one or more two positions in a word, among other things.

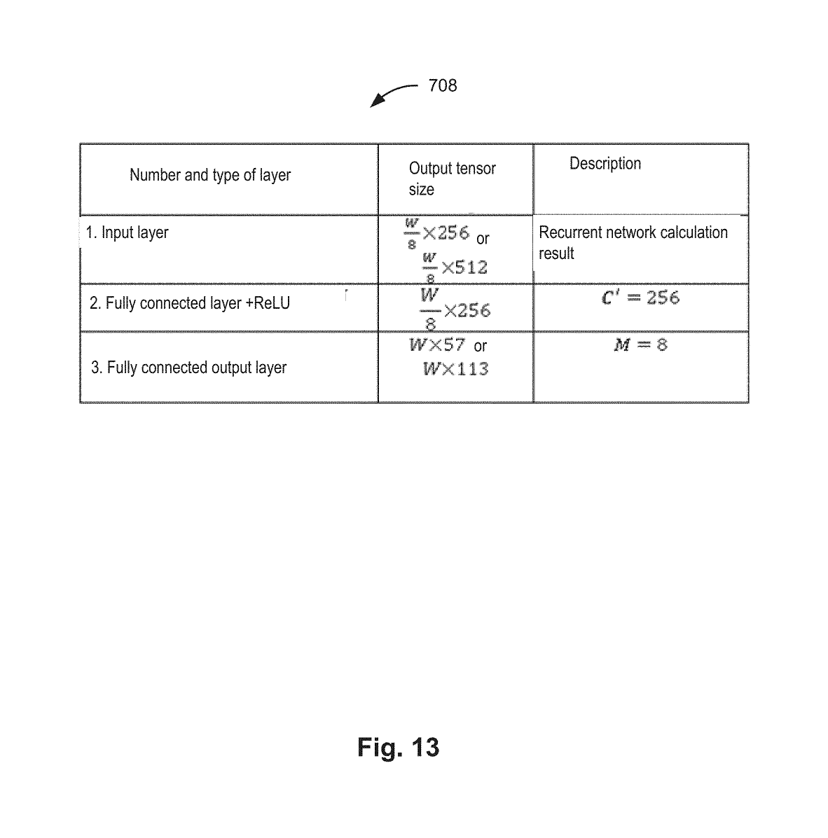

In a fully connected neural network, each neuron may transmit its output signal to the input of the remaining neurons, as well as itself. An example of the architecture of a fully connected neural network is shown in FIG. 13.

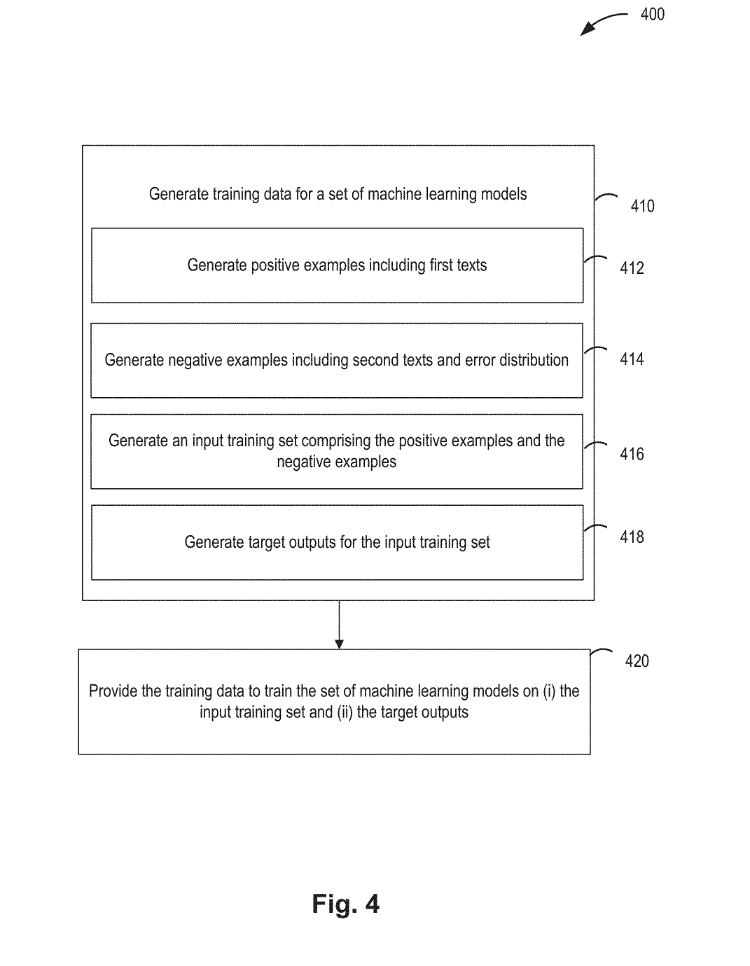

As noted above, the set of more machine learning models 114 may be trained to determine the most probable text in the image 141 using training data, as further described below with reference to method 400 of FIG. 4. Once the set of machine learning models 114 are trained, the set of machine learning models 114 can be provided to character recognition engine 112 for analysis of new images of text. For example, the character recognition engine 112 may input the image of the text 141 obtained from the document 140 being analyzed into the set of machine learning models 114. The character recognition engine 112 may obtain one or more final outputs from the set of trained machine learning models and may extract, from the final outputs, one or more predicted sentences from the text in the image 141. The predicted sentences may include a probable sequence of words and each word may include a probable sequence of characters. In some embodiments, the probable characters in the words are selected based on the context of the word (e.g., in relation to the other characters in the word) and the probable words are selected based on the context of the sentences (e.g., in relation to the other words in the sentence).

The repository 120 is a persistent storage that is capable of storing documents 140 and/or text images 141 as well as data structures to tag, organize, and index the text images 141. Repository 120 may be hosted by one or more storage devices, such as main memory, magnetic or optical storage based disks, tapes or hard drives, NAS, SAN, and so forth. Although depicted as separate from the computing device 110, in an implementation, the repository 120 may be part of the computing device 110. In some implementations, repository 120 may be a network-attached file server, while in other embodiments content repository 120 may be some other type of persistent storage such as an object-oriented database, a relational database, and so forth, that may be hosted by a server machine or one or more different machines coupled to the via the network 130.

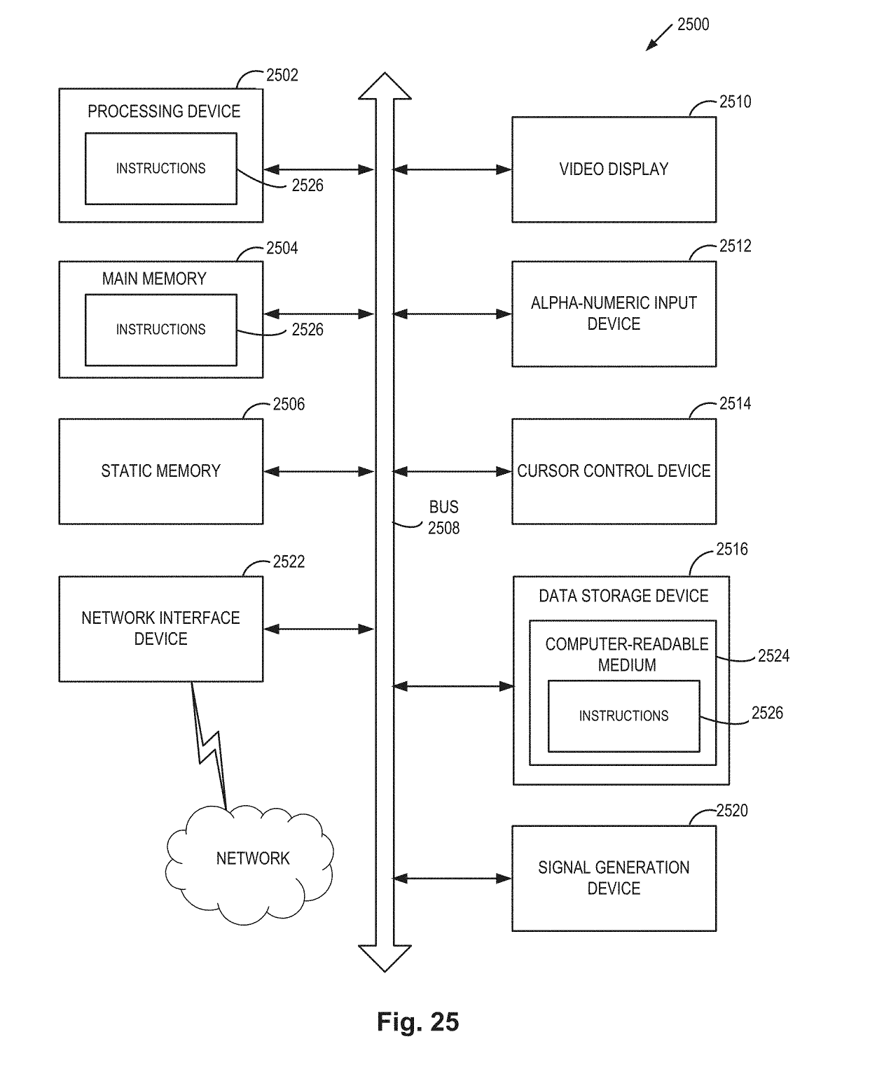

FIG. 4 depicts a flow diagram of an example method 400 for training a set of machine learning models 114 to identify a probable sequence of words for each of one or more sentences in an image 141 of text, in accordance with one or more aspects of the present disclosure. The method 400 is performed by processing logic that may include hardware (circuitry, dedicated logic, etc.), software (such as is run on a general purpose computer system or a dedicated machine), or a combination of both. The method 400 and/or each of their individual functions, routines, subroutines, or operations may be performed by one or more processors of a computing device (e.g., computing system 2500 of FIG. 25) implementing the methods. In certain implementations, the method 400 may be performed by a single processing thread. Alternatively, the method 400 may be performed by two or more processing threads, each thread implementing one or more individual functions, routines, subroutines, or operations of the methods. The method 400 may be performed by the training engine 151 of FIG. 1.

For simplicity of explanation, the method 400 is depicted and described as a series of acts. However, acts in accordance with this disclosure can occur in various orders and/or concurrently, and with other acts not presented and described herein. Furthermore, not all illustrated acts may be required to implement the method 400 in accordance with the disclosed subject matter. In addition, those skilled in the art will understand and appreciate that the method 400 could alternatively be represented as a series of interrelated states via a state diagram or events.

At block 410, a processing device may generate training data for the set of machine learning models 114. The training data for the set of machine learning models 114 may include positive examples and negative examples. At block 412, the processing device may generate positive examples including first texts. The positive examples may be obtained from documents published on the Internet, uploaded documents, or the like. In some embodiments, the positive examples include text corpora (e.g., Concordance). Text corpora may refer to a set of text corpus, which may include a large set of texts. Also, the negative examples may include text corpora and error distribution, as discussed below.

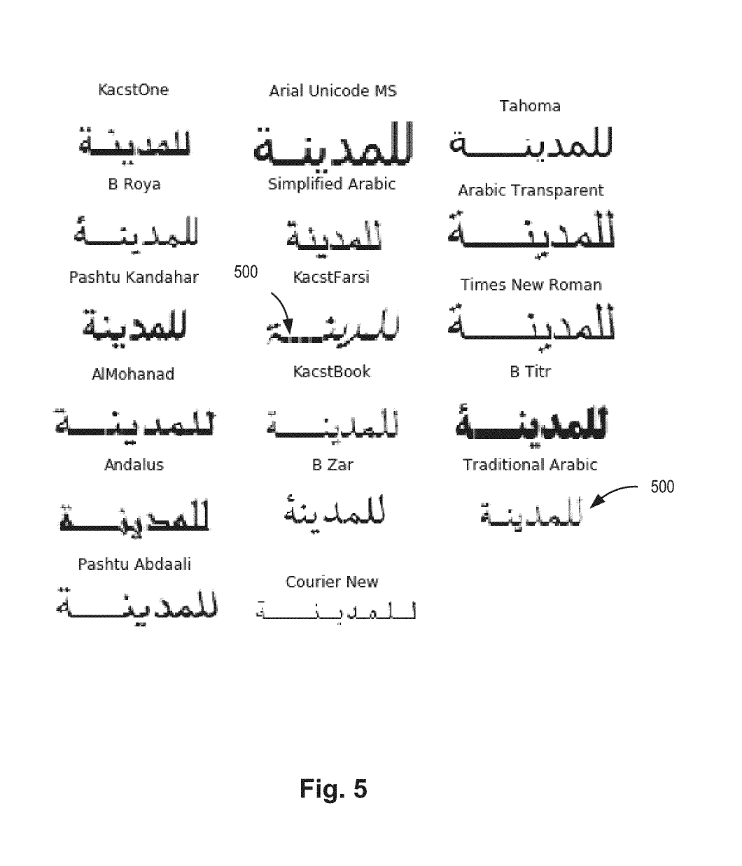

At block 414, the processing device may generate negative examples including second texts and error distribution. The negative examples may be dynamically created by converting texts executed in different fonts, for example, by imposing noises and distortions 500 similar to those that occur during scanning, as depicted in FIG. 5. That is, the second texts may include alterations that simulate at least one recognition error of one or more characters, one or more sequence of characters, or one or more sequence of words. Generating the negative examples may include using the positive examples and overlaying frequently encountered recognition errors on the positive examples.

To generate an error distribution used to generate a negative example, the processing device may divide a text corpus of a positive example into a first subset (e.g., 5% of the text corpus) and a second subset (e.g., 95% of the text corpus). The processing device may recognize rendered and distorted text images included the first subset. Actual images of text and/or synthetic images of text may be used. The processing device may verify the recognition of text by determining a distribution of recognition errors for the recognized text within the first subset. The recognition errors may include one or more of incorrectly recognized characters, sequence of characters, or sequence of words, dropped characters, etc. In other words, recognition errors may refer to any incorrectly recognized characters. Recognition errors may be at the level of one character, in a sequence of two characters (bigrams), in a sequence of three characters (trigrams), etc. The processing device may obtain the negative examples by modifying the second subset based on the distribution of errors.

At block 416, the processing device may generate an input training set comprising the positive examples and the negative examples. At block 418, the processing device may generate target outputs for the input training set. The target outputs may identify one or more predicted sentences in the text. The one or more predicted sentences may include a probable sequence of words.

At block 420, the processing device may provide the training data to train the set of machine learning models 114 on (i) the input training set and (ii) the target outputs. The set of machine learning models 114 may learn the compatibility of characters in sequences of characters and their frequency of use in sequence of characters and/or the compatibility of words in sequences of words and their frequency of use in sequences of words. Thus, the machine learning models 114 may learn to evaluate both the symbol in the word and the whole word. In some instances, a feature vector may be received during the learning process that is a sequence of numbers characterizing a symbol, a character sequence, or a sequence of words.

Once trained, the set of machine learning models 114 may be configured to process a new image of text and generate one or more outputs indicating the probable sequence of words for each of the one or more predicted sentences. Each word in each position of the probable sequence of words may be selected based on context of a word in an adjacent position (or any other position in a sequence of words) and each character in a sequence of characters may be selected based on context of a character in an adjacent position (or any other position in a word).

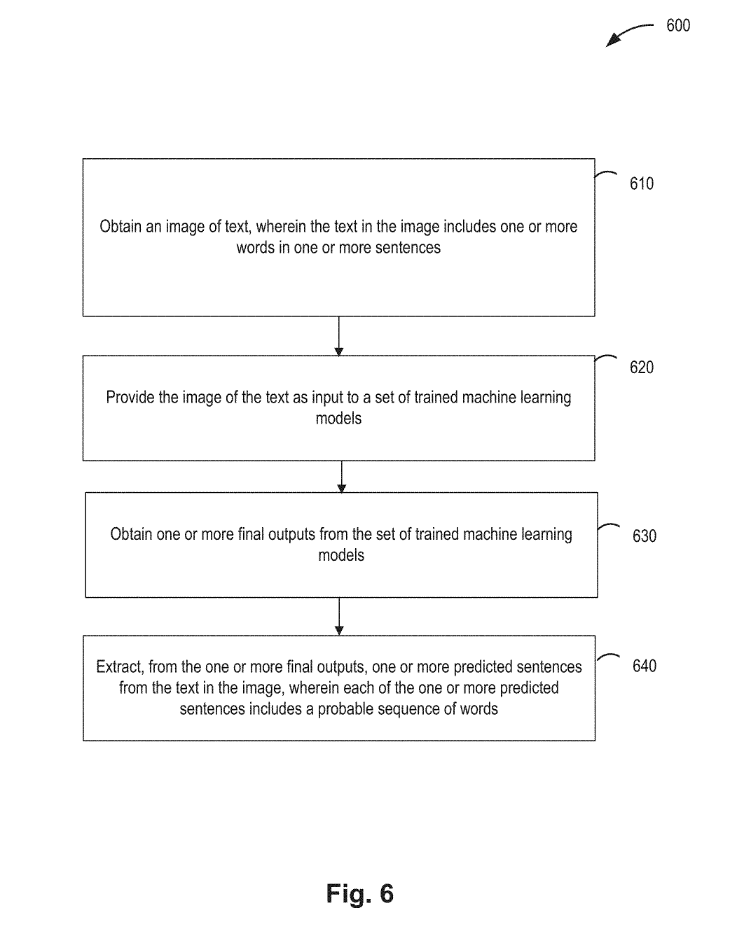

FIG. 6 depicts a flow diagram of an example method 600 for using the set of machine learning models 114 to recognize text from an image, in accordance with one or more aspects of the present disclosure. Method 600 includes operations performed by the computing device 110. The method 600 may be performed in the same or a similar manner as described above in regards to method 400. Method 600 may be performed by processing devices of the computing device 110 and executing the character recognition engine 112.

At block 610, a processing device may obtain an image 141 of text. The text in the image 141 includes one or more words in one or more sentences. Each of the words may include one or more characters. In some embodiments, the processing device may preprocess the image 141 as described above.

At block 620, the processing device may provide the image 141 of the text as input to the set of trained machine learning models 114. At block 630, the processing device may obtain one or more final outputs from the set of trained machine learning models 114. At block 640, the processing device may extract, from the one or more final outputs, one or more predicted sentences from the text in the image 141. Each of the one or more predicted sentences may include a probable sequence of words.

The set of machine learning models may include first machine learning models (e.g., combinations of convolutional neural network(s), recurrent neural network(s), and fully connected neural network(s)) trained to receive the image of the text as the first input and generate a first intermediate output for the first input, a second machine learning model (e.g., a character machine learning model) trained to receive a decoded first intermediate output as second input and generate a second intermediate output for the second input, and a third machine learning model trained (e.g., a word machine learning model) to receive the second intermediate output as third input and generate the one or more final outputs for the third input.

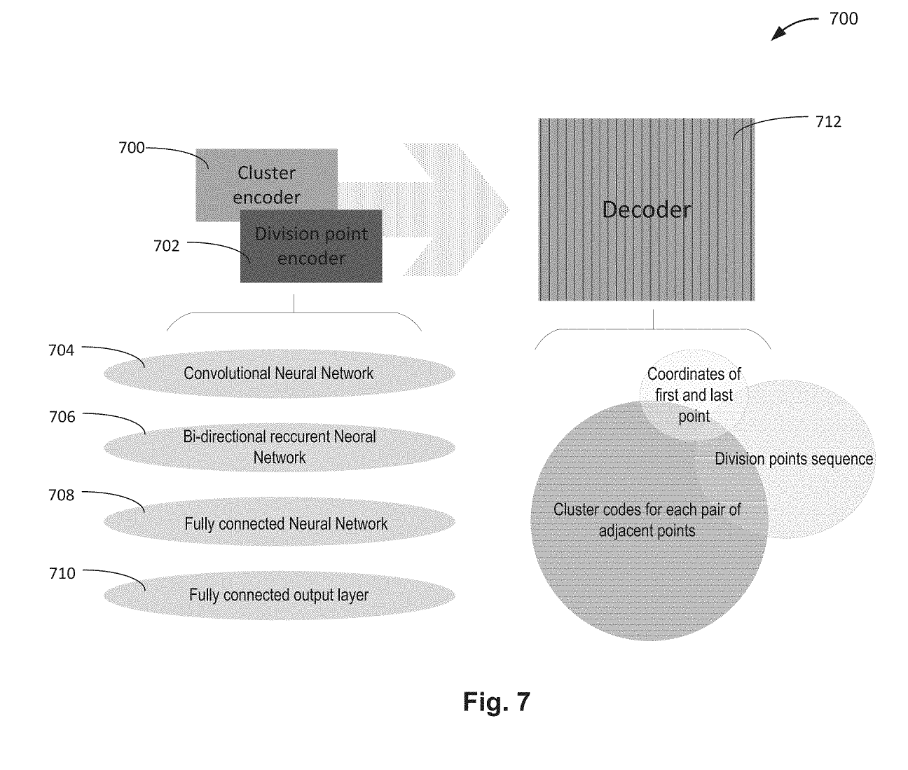

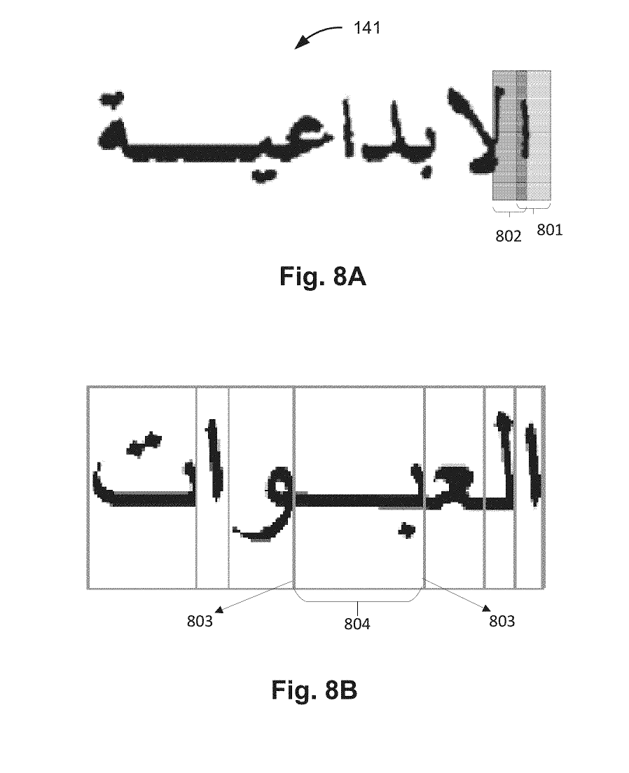

The first machine learning models may be implemented in a cluster encoder 700 and a division point encoder 702 that perform recognition, as depicted in FIG. 7. Implementations and/or architectures of the cluster encoder 700 and the division point encoder 702 are discussed further below with reference to FIGS. 8A/8B, 9, 10, 11, 12, and 13. The operation of recognition of the text in this disclosure is described by example in the Arabic language, but it should be understood that the operations may be applied to any other text, including handwritten text and/or ordinary spelling in print. The cluster encoder 700 and the division point encoder 702 may each include similar trained machine learning models, such as a convolutional neural network 704, a recurrent neural network 706, and a fully connected neural network 708 including a fully connected output layer 710. The cluster encoder 700 and the division point encoder 702 convert the image 141 (e.g., line image) into a sequence of features of the text in the image 141 as the first intermediate output. In some embodiments, the neural networks in the cluster encoder 700 and the division point encoder 702 may be combined into a single encoder that produces multiple outputs related to the sequence of features of the text in the image 141 as the first intermediate output. For example, a combination of a single convolutional neural network, a single recurrent neural network, and a single fully connected neural network may be used to output the features. The features may include information related to graphic elements representing one or more characters of the one or more words in the one or more sentences, and division points where the graphic elements are connected.

The cluster encoder 700 may traverse the image 141 using filters. Each filter may have a height equal to the image or less and may extract specific features in each position. The cluster encoder 700 may apply the combination of trained machine learning models to extract the information related to the graphic elements by multiplying values of one or more filters by each pixel value at each position in the image 141. The values of the filters may be selected in such a way that when they are multiplied by the pixel values in certain positions, information is extracted. The information related to the graphic elements indicates whether a respective position in the image 141 is associated with a graphic element, a Unicode code associated with a character represented by the graphic element, and/or whether the current position is a point of division.

For example, FIG. 8A depicts an example of extracting features in each position in the image 141 using the cluster encoder, in accordance with one or more aspects of the present disclosure. The cluster encoder 700 may apply one or more filters in a start position 801 to extract features related to the graphic elements. The cluster encoder 700 may shift the one or more filters to a second position 802 to extract the same features in the second position 802. The cluster encoder 700 may repeat the operation over the length of the image 141. Accordingly, information about the features in each position in the image 141 may be output, as well as information on the length of the image 141, counted in positions. FIG. 8B depicts an example of a word with division points 803 and a cluster 804 identified.

The division point encoder 702 may perform similar operations as the cluster encoder 700 but is configured to extract other features. For example, for each position in the image 141 to which the one or more filters of the division point encoder 702 are applied, the division point encoder 702 may extract whether the respective position includes a division point, a Unicode code of a character on the right of the division point, and a Unicode code of a character on the left of the division point.

The architectures of the cluster encoder 700 and the division point encoder 702 is now discussed in more detail with reference to FIGS. 9, 10, 11, 12, and 13. As previously noted, each encoder 700 and 702 includes a convolutional neural network, a recurrent neural network, a fully connected neural network, and a fully connected output layer. The convolutional neural network may convert a two-dimensional image 141 including text (e.g., Arabic word) into a one-dimensional sequence of features (e.g., cluster features for the cluster encoder 700 and division point features for the division point encoder 702). Further, for each of the cluster encoder 700 and the division point encoder 702, the sequence of features may be encoded by the recurrent neural network and the fully connected neural network.

FIG. 9 depicts an example of an architecture for a convolutional neural network 704 used by the encoders 700 and 702, in accordance with one or more aspects of the present disclosure. The convolutional neural network 704 includes an architecture for efficient image recognition. The convolutional neural network 704 includes a convolution operation, which may that each image position is multiplied by one or more filters (e.g., matrices of convolution), as described above, element-by-element, and the result is summed and recorded in a similar position of an output image. The convolutional neural network 704 may be applied to the received image 141 of text.

The convolutional neural network 704 includes an input layer and several layers of convolution and subsampling. For example, the convolutional neural network 704 may include a first layer having a type of input layer, a second layer having a type of convolutional layer plus rectified linear (ReLU) activation function, a third layer having a type of sub-discrete layer, a fourth layer having a type of convolutional layer plus ReLU activation function, a fifth layer having a type of sub-discrete layer, a sixth layer having a type of convolutional layer plus ReLU activation function, a seventh layer having a type of convolutional layer plus ReLU activation function, an eighth layer having a type of sub-discrete layer, a ninth layer having a type of convolutional layer plus ReLU activation function.

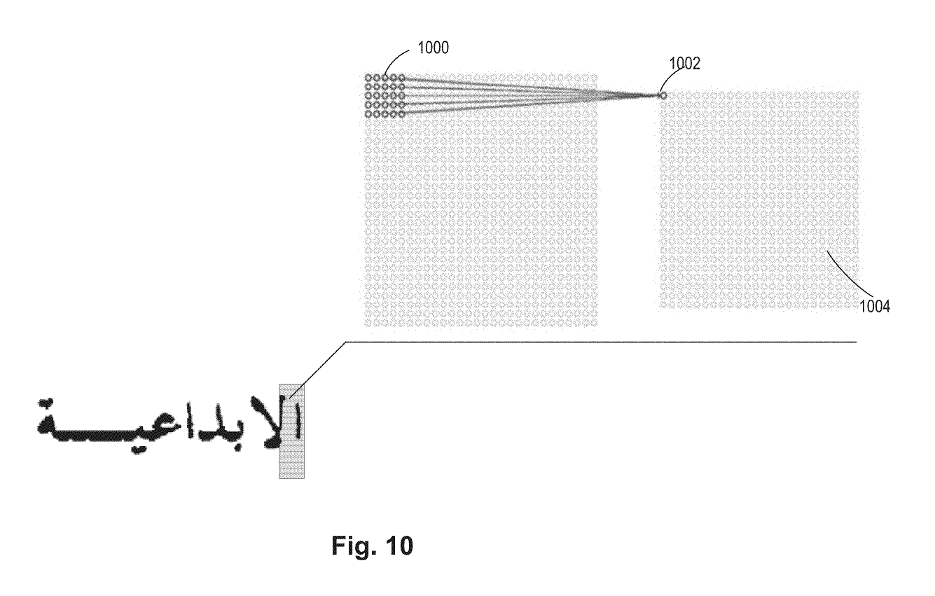

On the input layer, the pixel value of the image 141 is adjusted to the range of [−1, 1] depending on the color intensity. The input layer is followed by a convolution layer with a rectified linear (ReLU) activation function. In this convolutional layer, the value of the preprocessed image 141 is multiplied by the values of the one or more filters 1000, as depicted in FIG. 10. A filter is a pixel matrix having certain sizes and values. Each filter detects a certain feature. Filters are applied to positions traversed throughout the image 141. For example, a first position may be selected and the filters may be applied to the upper left corner and the values of each filter may be multiplied by the original pixel values of the image 141 (element multiplication) and these multiplications may be summed, resulting in a single number 1002.

The filters may be shifted through the image 141 to the next position in accordance with the convolution operation and the convolution process may be repeated for the next position of the image 141. Each unique position of the input image 141 may produce a number upon the one or more filters being applied. After the one or more filters pass through every position, a matrix is obtained, which is referred to as a feature map 1004. Further, the activation function (e.g., ReLU) is applied, which may replace negative numbers by zero, and may leave the position numbers unchanged. The information obtained by the convolution operation and the application of the activation function may be stored and transferred to the next layer in the convolutional neural network 704.

In column 900 (“Output tensor size”), information is provided on the tensor (e.g., an array of components) size output from that particular layer. For example, at layer number two having type convolutional layer plus ReLU activation function, the output is a tensor of sixteen feature maps having a size of 76×W, where W is the total length of the original image and 76 is the height after convolution.

In column 902 (“Description”), information about the parameters used at each layer are provided. For example, T indicates a number of filters, Kₕ indicates a height of the filters, K_{w} indicates a width of the filters, Pₕ indicates a number of white pixels added when convoluting along vertical borders, P_{w} indicates a number of white pixels that are added when convolving along horizontal boundaries, Sₕ indicates a convolution step in the vertical direction, and S_{w} indicates a convolution step in the horizontal direction.

The second layer (convolutional layer plus ReLU activation function) outputs the information as input to the third layer, which is a subsampling layer. The third layer performs an operation of decreasing the discretization of spatial dimensions (width and height), as a result of which the size of the feature maps decrease. For example, the size of the feature maps may decrease by two times because the filters may have a size of 2×2.

Further, the third layer may perform non-linear compression of the feature maps. For example, if some features have already been revealed in the previous convolution operation, then a detailed image is no longer needed for further processing, and it is compressed to less detailed pictures. In the subsampling layer, when a filter is applied to an image 141, no multiplication may be performed. Instead, a simpler mathematical operation is performed, such as searching for the largest number in the position of the image 141 being evaluated. The largest number found is entered in the feature maps, and the filter moves to the next position and the operation repeats until the end of the image 141 is reached.

The output from the third layer is provided as input to the fourth layer. The processing of the image 141 using the convolutional neural network 704 may continue applying each successive layer until every layer has performed its respective operation. Upon completion, the convolutional neural network 704 may output one hundred twenty-eight features (e.g., features related to the cluster or features related to division points) from the ninth layer (convolutional layer plus ReLU activation function) and the output may be provided as input to the recurrent neural network of the respective cluster encoder 700 and division point encoder 702.

An example recurrent neural network 706 used by the encoders 700 and 702 is depicted in FIG. 11. Recurrent neural networks may be capable of processing information sequences (e.g., sequences of features) and storing information about previous computations in the context of a hidden layer 1100. Accordingly, the recurrent neural network 706 may use the hidden layer 1100 as a memory for recalling previous computations. An input layer 1102 may receive a first sequence of features from the convolutional neural network 704 as input. A latent layer 1104 may analyze the sequence of features and the results of the analysis may be written into the context of the hidden layer 1100 and then sent to the output layer 1106.

A second sequence of features may be input to the input layer 1102 of the recurrent neural network 706. The processing of the second sequence of features in the hidden layer 1104 may take into account the context recorded when processing the first sequence of features. In some embodiments, the results of processing the second sequence of features may overwrite the context in the hidden layer 1104 and may be sent to the output layer 1106.

In some embodiments, the recurrent neural network 706 may be a bi-directional recurrent neural network. In bi-directional recurrent neural networks, information processing may occur from a first direction to a second direction (e.g., from left to right) and from the second direction to the first direction (e.g., from right to left). As such, contexts of the hidden layer 1100 store information about previous positions in the image 141 and about subsequent positions in the image 141. The recurrent neural network 706 may combine the information obtained from passage of processing the sequence of features in both directions and output the combined information.

It should be noted, that recording and analyzing information about previous and subsequent positions may enhance recognizing a merged letter, since the character width may exceed one or two positions. To accurately determine points of division, information may be used about what the clusters are at positions adjacent (e.g., to the right and the left) to the division point.

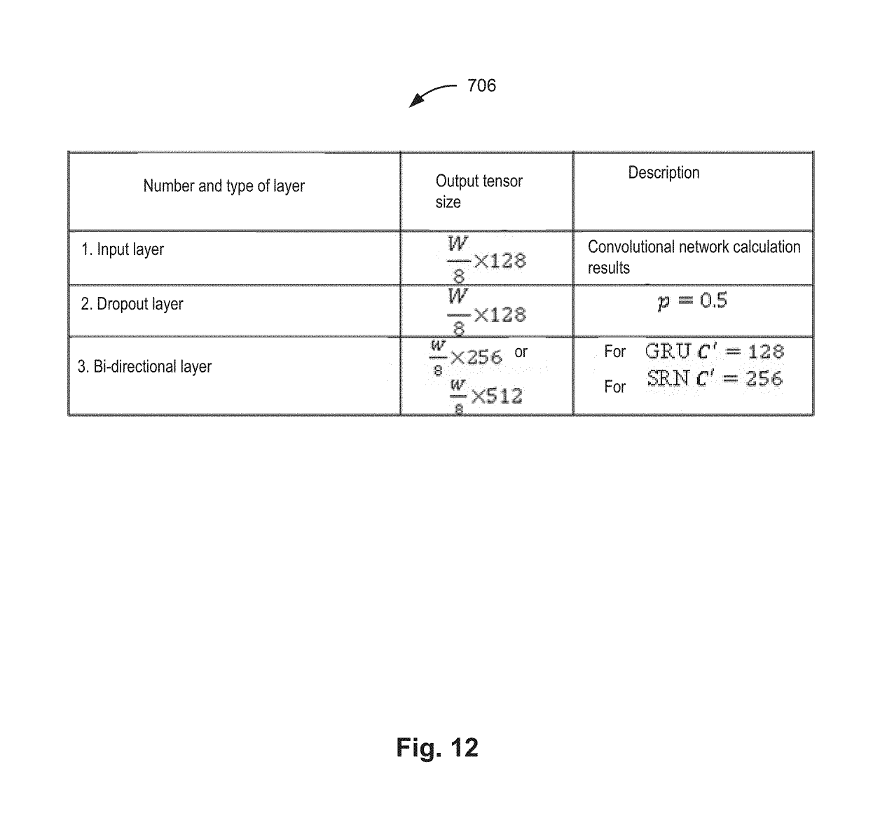

FIG. 12 depicts an example of an architecture for the recurrent neural network 706 used by the encoders 700 and 702, in accordance with one or more aspects of the present disclosure. The recurrent neural network 706 may include three layers, a first layer having a type of input layer, a second layer having a type of dropout layer, and a third layer having a type of bi-directional layer (e.g., recurrent neural network, bi-directional gated recurrent unit (GRU), long short-term memory (LSTM), or another suitable bi-directional neural network).

The sequence of one hundred twenty-eight features output by the convolutional neural network 704 may be input at the input layer of the recurrent neural network 706. The sequence may be processed through the dropout layer (e.g., regularization layer) to avoid retraining the recurrent neural network 706. The third layer (bi-directional layer) may combine the information obtained during passage in both directions. In some implementations, a bi-directional GRU may be used as the third layer, which may result in two hundred fifty six features output. In another implementation, a bi-directional recurrent neural network may be used as the third layer, which may result in five hundred twelve features output.

In another embodiment, instead of a recurrent neural network, a second convolutional neural network may be used to receive the output (e.g., sequence of one hundred twenty features) from the first convolutional neural network. The second convolutional neural network may implement wider filters to encompass a wider position on the image 141 to account for clusters that are at adjacent positions (e.g., neighboring clusters) to the cluster in a current position and to analyze the image of a sequence of symbols during at once.

The encoders 700 and 702 may continue recognizing the text in the image 141 by the recurrent neural network 706 sending its output to the fully connected neural network 708. FIG. 13 depicts an example of an architecture for a fully connected neural network used by the encoders 700 and 702, in accordance with one or more aspects of the present disclosure. The fully connected neural network 708 may include three layers, such as a first layer having a type of input layer, a second layer having a type of fully connected layer plus a ReLU activation function, and a third layer having a type of fully connected output layer 710.

The input layer of the fully connected neural network 708 may receive the sequence of features output by the recurrent neural network 706. The fully connected neural network layer may perform a mathematical transformation on the sequence of features to output a tensor size of a sequence of two hundred fifty-six features (C′). The third layer (fully connected output layer) may receive the sequence of features output by the second layer as input. For each feature in the received sequence of features, the fully connected output layer may compute the M neighboring features of the output sequence. As a result, the sequence of features is extended by M times. Extending the sequence may compensate for the decrease in length after the convolutional neural network 704 performs its operations. For example, during image processing, the convolutional neural network 704 described above may compress data in such a way that eight columns of pixels produce one column of pixels. As such, M in the illustrated example is eight. However, any suitable M may be used based on the compression accomplished by the convolutional neural network 704.

It should be understood that the convolutional neural network 704 may compress data in an image, the recurrent neural network 706 may process the compressed data, and the fully connected output layer of the fully connected neural network 708 may output decompressed data. The sequence of features related to graphic elements representing clusters and division points output by the first machine learning models (e.g., convolutional neural network 704, recurrent neural network 706, and fully connected neural network 708) of each of the encoders 702 and 704 may be referred to as the first intermediate output, as noted above. The first intermediate output may be provided as input to a decoder 712 (depicted in FIG. 7) for processing.

The first intermediate output may be processed by the decoder 712 to output decoded first intermediate output for input to the second machine learning model (e.g., a character machine learning model). The decoder 712 may decode the sequence of features of the text in the image 141 and output one or more sequences of characters for each word in the one or more sentences of the text in the image 141. That is, the decoder 712 may output a recognized one or more sequences of characters as the decoded first intermediate output.

The decoder 712 may be implemented as instructions using dynamic programming techniques. Dynamic programming techniques may enable solving a complex problem by splitting it into several smaller subtasks. For example, a processing device that executes the instructions to solve a first subtask can use the obtained data to solve the second subtask, and so forth. A solution of the last subtask is the desired answer to the complex problem. In some embodiments, the decoder solves the complex problem of determining the sequence of characters represented in the image 141.

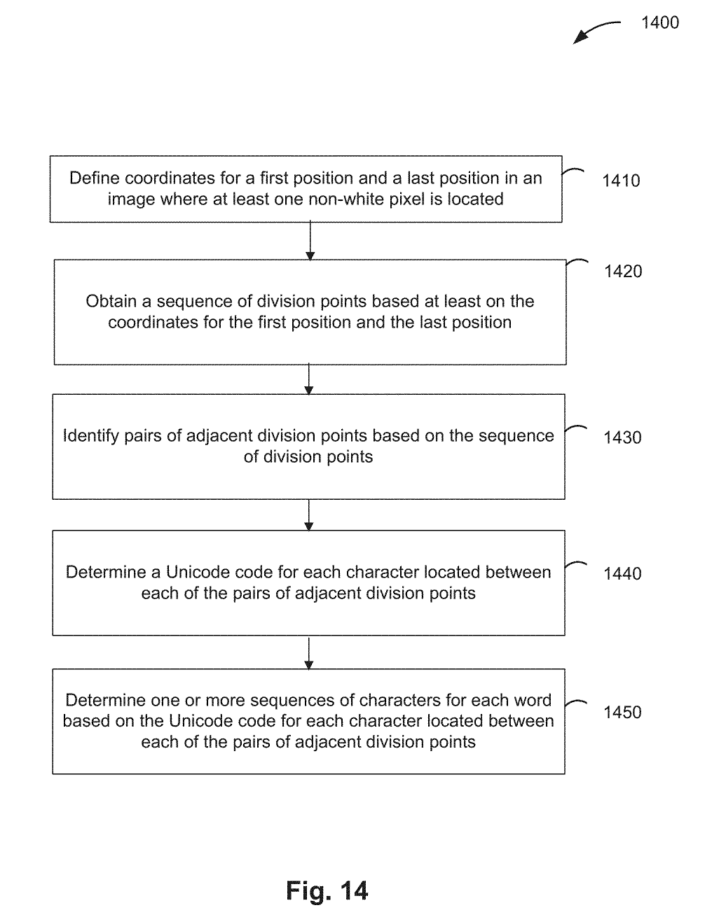

For example, FIG. 14 depicts a flow diagram of an example method 1400 for using the decoder 712 to determine sequences of characters for words in an image 141, in accordance with one or more aspects of the present disclosure. Method 1400 includes operations performed by the computing device 110. The method 1400 may be performed in the same or a similar manner as described above in regards to method 400. Method 1400 may be performed by processing devices of the computing device 110 and executing the character recognition engine 112.

At block 1410, a processing device may define coordinates for a first position and a last position in an image. In some embodiments, the first position and the last position include at least one foreground (e.g., non-white) pixel.

At bock 1420, a processing device may obtain a sequence of division points based at least on the coordinates for the first position and the last position. In an embodiment, the processing device may determine whether the sequence of division points is correct. For example, the sequence of division points may be correct if there is no third division point between two division points, if there is a single symbol between the two division points, and the output to the left of the current division point coincides with the output to the right of the previous division point, etc.

At block 1430, a processing device may identify pairs of adjacent division points based on the sequence of division points. At block 1440, a processing device may determine a Unicode code or any suitable code for each character located between each of the pairs of adjacent division points. In some embodiments, determining the Unicode code for each character may include maximizing a cluster estimation function (e.g., identifying the Unicode code that receives the highest value from a cluster estimation function based on the sequence of features).

At block 1450, a processing device may determine one or more sequences of characters for each word based on the Unicode code for each character located between each of the pairs of adjacent division points. The one or more sequences of characters for each word may be output as the decoded first intermediate output. In some implementations, the decoder 712 may output just the most probable image recognition option (e.g., sequence of characters for each word). In another embodiment, the decoder 712 may output a set of probable image recognition options (e.g., sequences of characters for each word). In embodiments where several recognition variants (e.g., several sequence of characters) are obtained, the most probable of the symbol sequences may be determined by the second machine learning model (e.g., character machine learning model). The second machine learning model may be trained to output the second intermediate output, which includes one or more probable sequences of characters for each word selected from one or more sequences of characters for each word included in the decoded first intermediate output, as described further below.

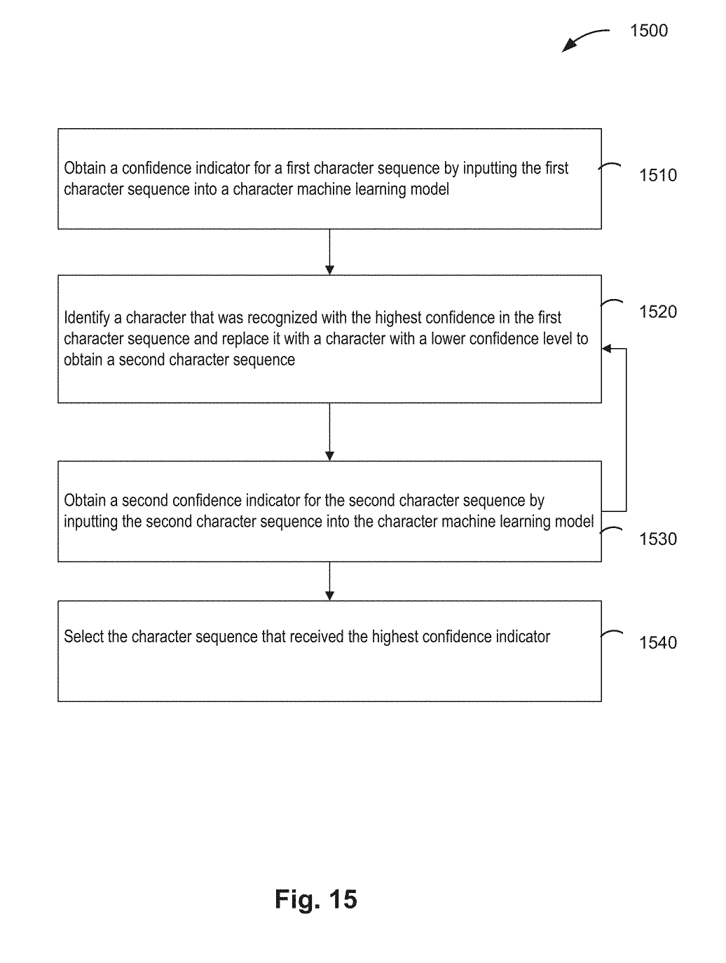

FIG. 15 depicts a flow diagram of an example method 1500 for using a second machine learning model (e.g., character machine learning model) to determine the most probable sequence of characters in the context of the words, in accordance with one or more aspects of the present disclosure. Method 1500 includes operations performed by the computing device 110. The method 1500 may be performed in the same or a similar manner as described above in regards to method 400. Method 1500 may be performed by processing devices of the computing device 110 and executing the character recognition engine 112. Method 1500 may perform character-by-character analysis of recognition results (decoded first intermediate output) to select the most probable characters in the context of a word. The character machine learning model described in the method 1500 may receive a sequence of characters from the first machine learning models and output a confidence index from 0 to 1 for the sequence of characters being a real word.

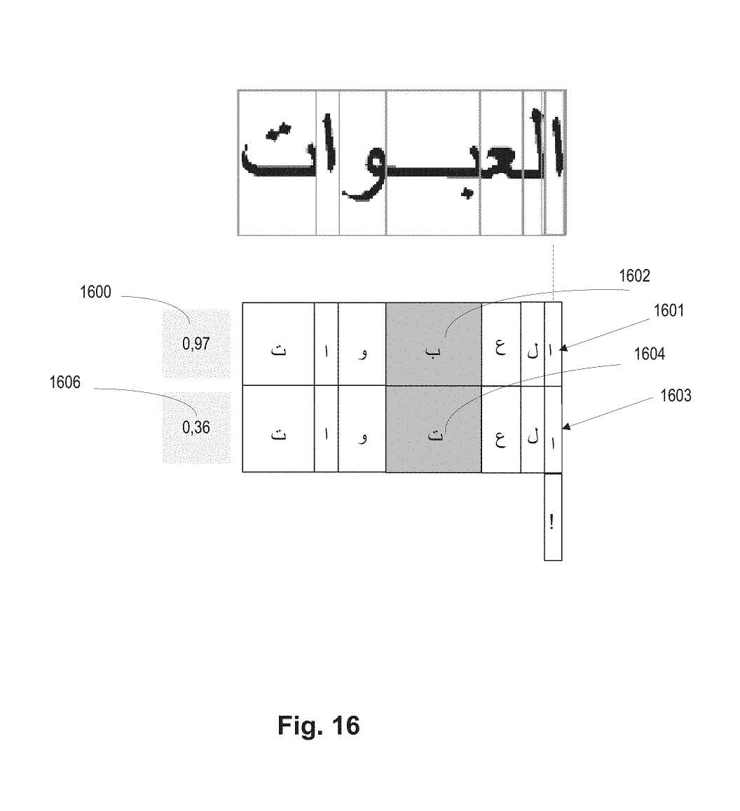

FIG. 16 depicts an example of using the character machine learning model described with reference to the method in FIG. 15, in accordance with one or more aspects of the present disclosure. For purposes of clarity, FIG. 15 and FIG. 16 are described together below.

At block 1510, a processing device may obtain a confidence indicator 1600 for a first character sequence 1601 (e.g., decoded first intermediate output) by inputting the first character sequence 1601 into a trained character machine learning model. At block 1520, the processing device may identify a character 1602 that was recognized with the highest confidence in the first character sequence and replace it with a character 1604 with a lower confidence level to obtain a second character sequence 1603.

At block 1530, the processing device may obtain a second confidence indicator 1606 for the second character sequence 1603 by inputting the second character sequence 1603 into the trained character machine learning model. The processing device may repeat blocks 1520 and 1530 a specified number of times or until the confidence indicator of a character sequence exceeds a predefined threshold. At block 1540, the processing device may select the character sequence that receives the highest confidence indicator.

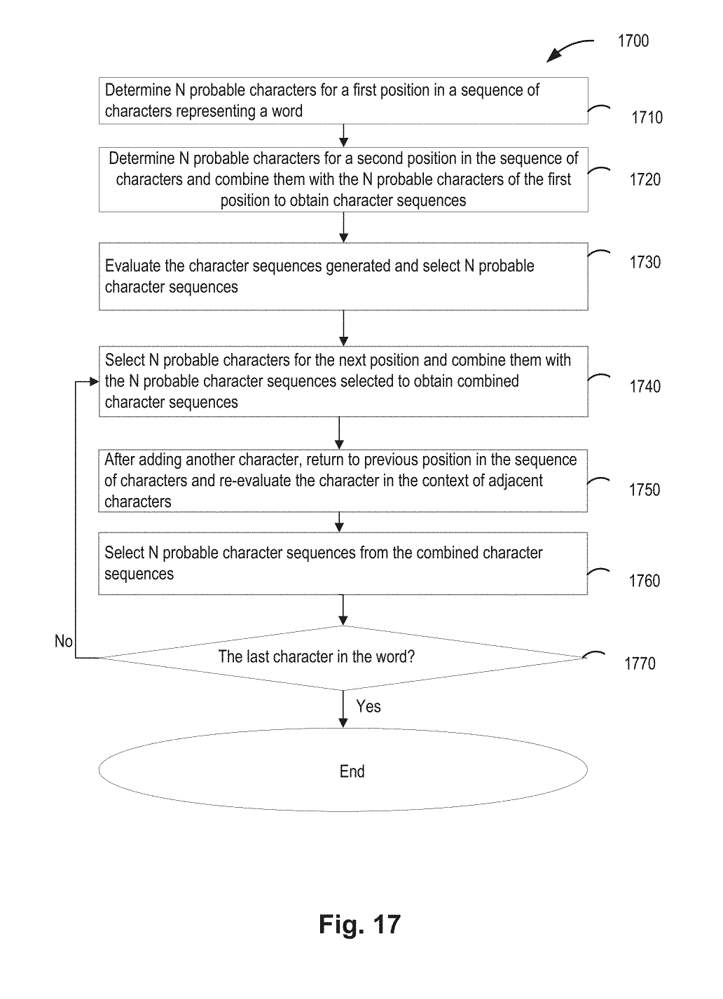

FIG. 17 depicts a flow diagram of another example method 1700 for using a character machine learning model to determine the most probable sequence of characters in the context of the words, in accordance with one or more aspects of the present disclosure. Method 1700 includes operations performed by the computing device 110. The method 1700 may be performed in the same or a similar manner as described above in regards to method 400. Method 1700 may be performed by processing devices of the computing device 110 and executing the character recognition engine 112. Method 1700 may perform character-by-character analysis of recognition results (decoded first intermediate output) to select the most probable characters in the context of a word. Method 1700 may be implemented as a beam search method that expands the most promising node in a limited set. Beam search method may refer to an optimization of best-first search that reduces its memory requirements by discarding undesirable candidates.

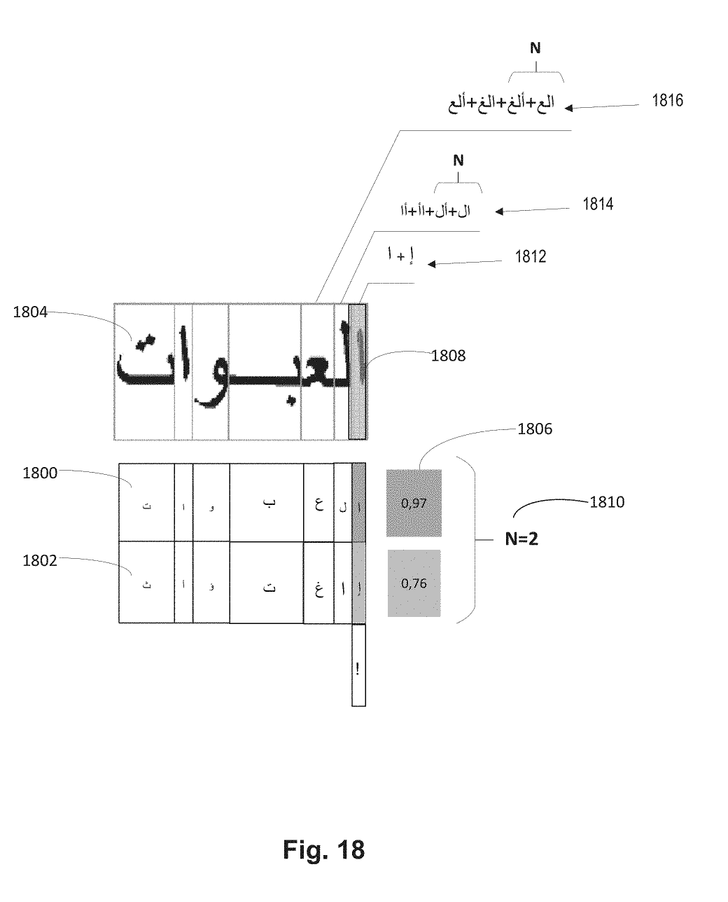

FIG. 18 depicts an example of using the character machine learning model described with reference to the method in FIG. 17, in accordance with one or more aspects of the present disclosure. For purposes of clarity, FIG. 17 and FIG. 18 are described together below. As depicted in FIG. 18, there may be several character recognition options (1800 and 1802) with relatively high confidence indicators (e.g., probable characters) for each position (1804) of a word in the image 141. The most probable options are those with the highest confidence indicators (1806).

At block 1710, a processing device may determine N probable characters for a first position 1808 in a sequence of characters representing a word based on the image recognition results from the decoded first intermediate output. Since the operations of the symbolic analysis are illustrated in the Arabic language, the positions are considered from right to left. The first position is the extreme right position. N (1810) in the illustrated example is 2, so the processing device selects the two best recognition options, the “ [symbol] ” and “ [symbol] ” symbols, as shown at 1812.

At block 1720, the processing device may determine N probable characters (“ [symbol] ” and “ [symbol] ”) for a second position in the sequence of characters and combine them with the N probable characters (“ [symbol] ” and “ [symbol] ”) of the first position to obtain character sequences. Accordingly, four character sequences each having two characters may be generated ( [symbol] + [symbol] + [symbol] + [symbol] ), as show at 1814.

At block 1730, the processing device may evaluate the character sequences generated and select N probable character sequences. The processing device may take into account the confidence indicators obtained for the symbols during recognition and the evaluation obtained at the output from the trained character machine learning model. In the depicted example, out of four double-character sequences, two may be selected: “ [symbol] + [symbol] ”.

At block 1740, the processing device may select N probable characters for the next position and combine them with the N probable character sequences selected to obtain combined character sequences. As such, in the depicted example, the processing device generates four three-character sequences: “ [symbol] + [symbol] + [symbol] + [symbol] ” at 1816.

At block 1750, after adding another character, the processing device may return to a previous position in the sequence of characters and re-evaluate the character in the context of adjacent characters (e.g., neighboring characters to the right and/or the left of the added character) or other characters in different positions in the sequence of characters. This may improve accuracy in the recognition analysis by considering each character in the context of the word.

At block 1760, the processing device may select N probable character sequences from the combined character sequences as the best symbolic sequences. As shown in the depicted example, the processing device selects N (2) (e.g., “ [symbol] + [symbol] ”) out of the four three-character sequences by taking into account the confidence indicators obtained for the symbols in recognition and the evaluation obtained at the output form the trained character machine learning model.

At block 1770, the processing device may determine whether the last character in the word has been selected. If not, the processing device may return to executing block 1740 to select N probable characters for the next position and combine them with the N probable character sequences selected to obtained combined character sequences until N character sequences are found that include every character of the word. If yes, then the character-by-character analysis may be completed and N character sequences that include every character of the word may be selected.

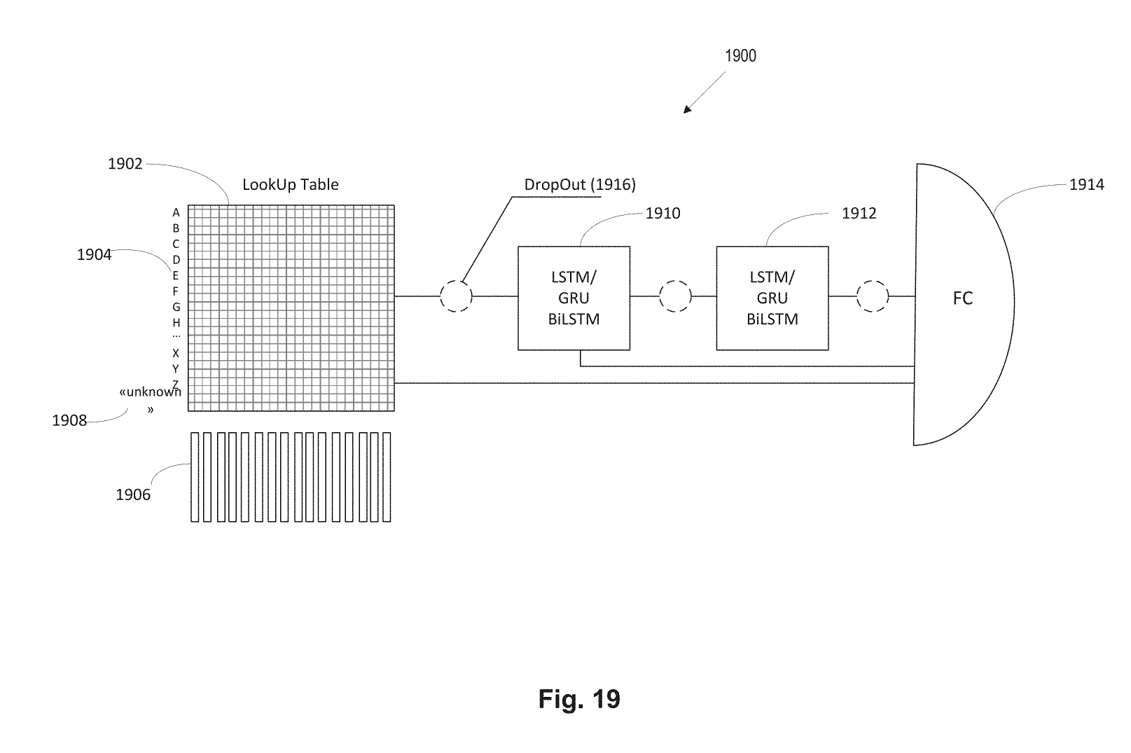

The character machine learning model described above with reference to method 1500 and 1700 may be implemented using various neural networks. For example, recurrent neural networks (depicted in FIG. 19) that are configured to store information may be used. Additionally, a convolutional neural network (depicted in FIG. 20) may be used to implement the character machine learning model. Further, a neural network may be used in which the direction of processing sequences occurs from left to right, right to left, or in both directions depending on the direction and complexity of the letter. Also, the neural network may consider the analyzed characters in the context of the word by taking into account characters in adjacent positions (e.g., right, left, both) or other positions to the character in the current position being analyzed depending on the direction of processing of the sequences.

FIG. 19 depicts an example of the character machine learning model implemented as a recurrent neural network 1900, in accordance with one or more aspects of the present disclosure. The recurrent neural network 1900 may include a first layer 1902 represented as a lookup table. In this layer 1902, each symbol 1904 is assigned an embedding 1906 (feature vector). The lookup table may vertically include the values of every character plus one special character “unknown” 1908 (unknown or low-frequency symbols in a particular language). The vectors of the features may have a length of 8-32, and 64-128 literal numbers. The size of the vector may be configurable depending on the language.

A second layer 1910 is GRU, LSTM, or bi-directional LSTM. A third layer 1912 is also GRU, LSTM, or bi-directional LSTM. A fourth layer 1914 is a fully-connected layer. This layer 1914 adds the output of the previous layers to the weights and outputs a confidence indicator from 0 to 1 after applying the activation function. In some implementations, a sigmoid activation function may be used. Between the layers, a regularization layer 1916, for example, dropout or batchNorm, may be used.

FIG. 20 depicts an example architecture of the character machine learning model implemented as a convolutional neural network 2000, in accordance with one or more aspects of the present disclosure. The convolutional neural network 2000 may include a first layer represented as a lookup table. In the first layer, each symbol is assigned a feature vector embedding 2002. The lookup table may vertically include the values of every character plus one special character “unknown” (unknown or low-frequency symbols in a particular language). The vectors of the features may have a length of 8-32, and 64-128 literal numbers. The size of the vector may be configurable depending on the language.

A second layer 2004 includes K convolution layers. The input of each layer may be given a sequence of character embeddings. The sequence of character embedding is subjected to a time convolution operation (2006), which is a convolution operation similar to that described with reference to the architecture of the convolutional neural network 704 described above with reference to FIGS. 9 and 10.

Convolution can be made by filters of different sizes (e.g., 8×2, 8×3, 8×4, 8×5), where the first number corresponds to the embedding size. The number of filters may be equal to the number of numbers in an embedding. For a filter of size 2 (2008), the embeddings of the first two characters may be multiplied by the weights of the filters. The filter of size 2 may be shifted by one embedding and multiples the embeddings of the second and third characters by the filter. The filter may be shifted until the end of the embedding sequence. Further, a similar process may be executed for a filter of size 3, size 4, size 5, etc.

A ReLU activation function 2010 may be applied to the results obtained by the traversals of the filters applied to the embeddings. Additionally, MaxOverTimePooling (time-based pooling) filters may be applied to the results of the ReLU activation function. MaxOverTimePooling filters find maximum values in the embedding and pass them to the next layer. this combination of convolution, activation, and pooling may be performed a configurable amount of times. A third layer 2014 includes concatenation. This layer 2014 may receive the results from the MaxOverTimePooling functions and combine the results to output a feature vector. The feature vector may include a sequence of numbers characterizing a given symbol.

Using the character machine learning model, embodiments may input the decoded first intermediate output and generate the second intermediate output. The second intermediate output may include one or more probable sequences of characters for each word selected from one or more sequences of characters for each word included in the decoded first intermediate output. After the most probable character sequences for the one or more words in the one or more sentences in the text in the image 141 are determined, word-by-word analysis may be performed by a third machine learning model (e.g., word machine learning model) to predict sentences including one or more probable words based on the context of the sentences. That is, the third machine learning model may receive the second intermediate output and generate the one or more final outputs that are used to extract the one or more predicted sentences from the text in the image 141.

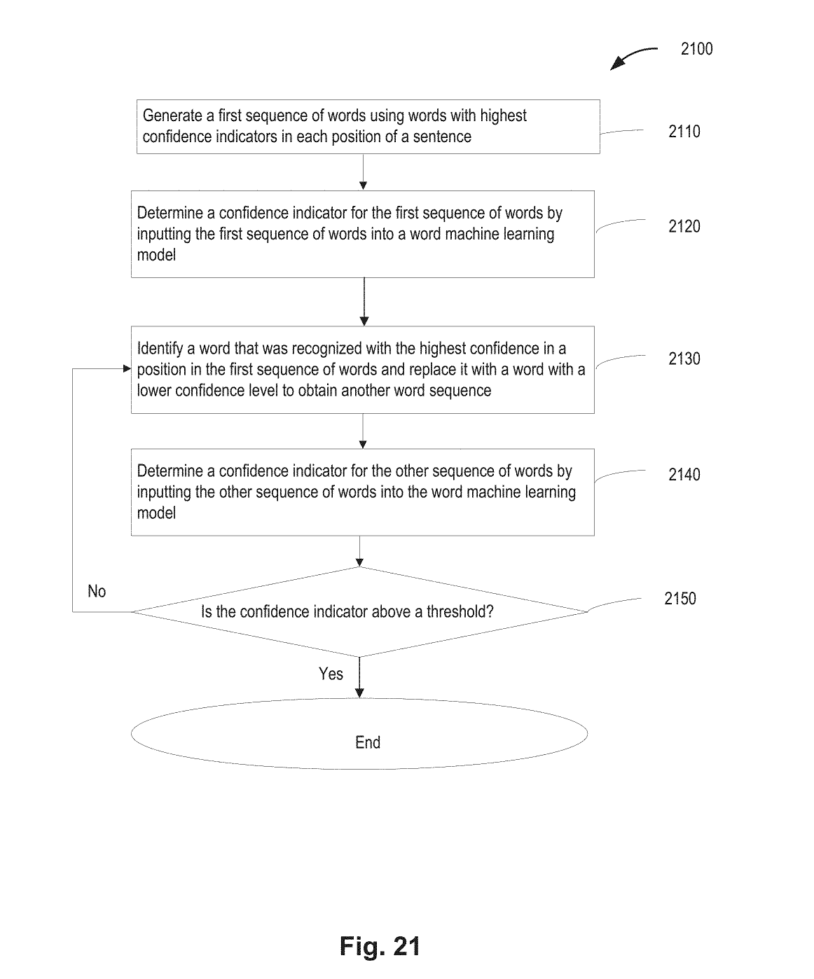

FIG. 21 depicts a flow diagram of an example method 2100 for using a third machine learning model (e.g., word machine learning model) to determine the most probable sequence of words in the context of the sentences, in accordance with one or more aspects of the present disclosure. Method 2100 includes operations performed by the computing device 110. The method 2100 may be performed in the same or a similar manner as described above in regards to method 400. Method 2100 may be performed by processing devices of the computing device 110 and executing the character recognition engine 112. Prior to the method 210 executing, the processing device may receive the second intermediate output (one or more probable sequences of characters for each word in one or more sentences) from the second machine learning model (character machine learning model).

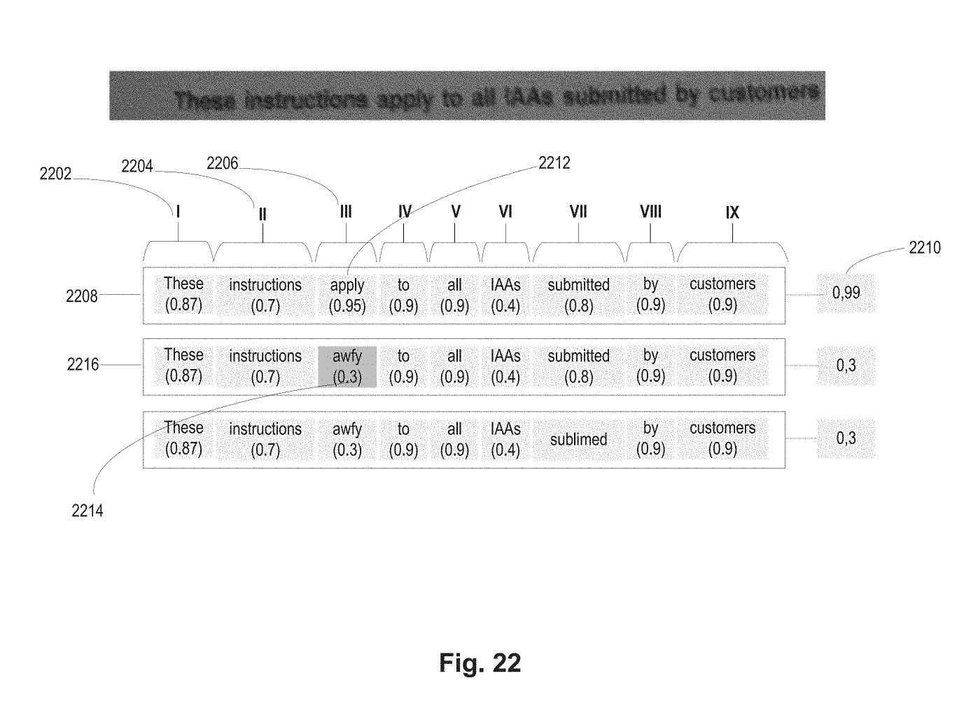

FIG. 22 depicts an example of using the word machine learning model described with reference to the method in FIG. 21, in accordance with one or more aspects of the present disclosure. For purposes of clarity, FIGS. 21 and 22 are discussed together below.

At block 2110, a processing device may generate a first sequence of words 2208 using the words (sequences of characters) with the highest confidence indicators in each position of a sentence. In the depicted example in FIG. 22, the words with the highest confidence indicator include: “These” for the first position 2202, “instructions” for the second position 2204, “apply” for the third position 2206, etc. In some embodiments, the selected words may be collected in a sentence without violating their sequential order. For example, “These” is not shifted to the second position 2204 or the third position 2206.

At block 2120, the processing device may determine a confidence indicator 2210 for the first sequence of words 2208 by inputting the first sequence of words 2208 into the word machine learning model. The word machine learning model may output the confidence indicator 2210 for the first sequence of words 2208.

At block 2130, the processing device may identify a word (2212) that was recognized with the highest confidence in a position in the first sequence of words 2208 and replace it with a word (2214) with a lower confidence level to obtain another word sequence 2216. As depicted, the word “apply” (2212) with the highest confidence of 0.95 is replaced with a word “awfy” (2214) having a lower confidence of 0.3.

At block 2140, the processing device may determine a confidence indicator for the other sequence of words 2216 by inputting the other sequence of words 2216 into the word machine learning model. At block 2150, the processing device may determine whether a confidence indicator for the sequence of words is above a threshold. If so, the sequence of words having the confidence indicator above a threshold may be selected. If not, the processing device may return to execution of blocks 2130 and 2140 for additional sentence generation for a specified number of times or until a word combination is found whose confidence indicator exceeds the threshold. If the blocks are repeated a predetermined number of times without exceeding the threshold, then at the end of the entire set of generated word combinations, the processing device may select the word combination that received the highest confidence indicator.

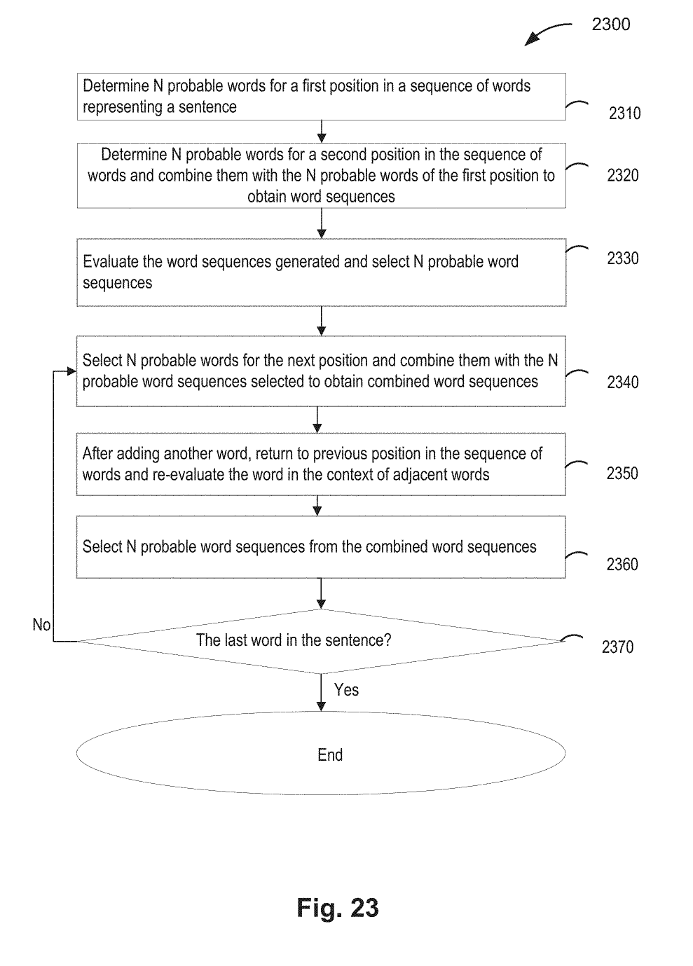

FIG. 23 depicts a flow diagram of another example method 2300 for using a word machine learning model to determine the most probable sequence of characters in the context of the words, in accordance with one or more aspects of the present disclosure. Method 2300 includes operations performed by the computing device 110. The method 2300 may be performed in the same or a similar manner as described above in regards to method 400. Method 2300 may be performed by processing devices of the computing device 110 and executing the character recognition engine 112. Method 2300 may be implemented as a beam search method that expands the most promising node in a limited set. Beam search method may refer to an optimization of best-first search that reduces its memory requirements by discarding undesirable candidates. In the predicted sentences, for each position, there may be several options with high confidence indicators (e.g., probable) and the method 2300 may select the N most probable options for each position of the sentences.

At block 2310, a processing device may determine N probable words for a first position in a sequence of words representing a sentence based on the second intermediate output (e.g., one or more probable sequences of characters for each word). At block 2320, the processing device may determine N probable words for a second position in the sequence of words and combine them with the N probable words to the first position to obtain word sequences.

At block 2330, the processing device may evaluate the word sequences generated using the trained word machine learning model and select N probable word sequences. When selecting, the processing device may take into account the confidence indicators obtained by words during recognition or as identified by the trained character machine learning model, and the evaluation obtained at the output from the trained word machine learning model. At block 2340, the processing device may select N probable words for the next position and combine them with the N probable word sequences selected to obtain combined word sequences.

At block 2350, the processing device may, after adding another word, return to a previous position in the sequence of words and re-evaluate the word in the context of adjacent words (e.g., in the context of the sentence) or other words in different positions in the sequence of words. Block 2350 may enable achieving greater accuracy in recognition by considering the word at each position in context of other words in the sentence. At block 2360, the processing device may select N probable word sequences from the combined word sequences.

At block 2370, the processing device may determine whether the last word in the sentence was selected. If not, the processing device may return to block 2340 to continue selecting probable words for the next position. If yes, then word-by-word analysis may be completed and the processing device may select the most probable sequence of words as the predicted sentence from N number of word sequences (e.g., sentences).

The word machine learning model described above with reference to method 2100 and 2300 may be implemented using various neural networks. The neural networks may have similar architectures as described above for the character machine learning model. For example, the word machine learning model may be implemented as a recurrent neural networks (depicted in FIG. 19). Additionally, a convolutional neural network (depicted in FIG. 20) may be used to implement the word machine learning model. In the trained machine learning model, embeddings may correspond to words and groups of words that are united by categories (e.g., “unknown,” “number,” “date.”

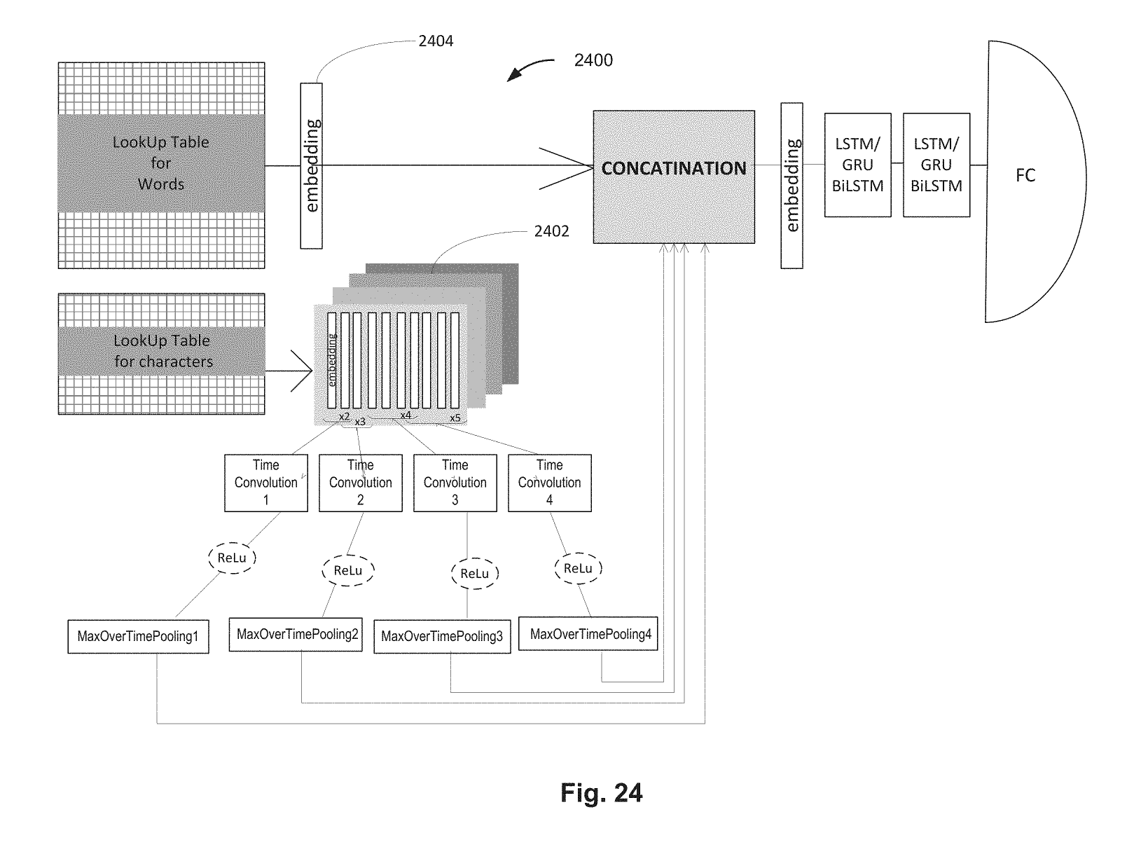

An additional architecture 2400 of an implementation of the word machine learning model is depicted in FIG. 24. The example architecture 2400 implements the word machine learning model as a combination of the convolutional neural network implementation of the character machine learning model (depicted in FIG. 20) and a recurrent neural network for the words. Accordingly, the architecture 2400 may compute feature vectors at the level 2402 of the character sequence and may compute features at the level 2404 of the word sequence.

FIG. 25 depicts an example computer system 2500 which can perform any one or more of the methods described herein, in accordance with one or more aspects of the present disclosure. In one example, computer system 2500 may correspond to a computing device capable of executing character recognition engine 112 of FIG. 1. In another example, computer system 2500 may correspond to a computing device capable of executing training engine 151 of FIG. 1. The computer system may be connected (e.g., networked) to other computer systems in a LAN, an intranet, an extranet, or the Internet. The computer system may operate in the capacity of a server in a client-server network environment. The computer system may be a personal computer (PC), a tablet computer, a set-top box (STB), a personal Digital Assistant (PDA), a mobile phone, a camera, a video camera, or any device capable of executing a set of instructions (sequential or otherwise) that specify actions to be taken by that device. Further, while only a single computer system is illustrated, the term “computer” shall also be taken to include any collection of computers that individually or jointly execute a set (or multiple sets) of instructions to perform any one or more of the methods discussed herein.

The exemplary computer system 2500 includes a processing device 2502, a main memory 2504 (e.g., read-only memory (ROM), flash memory, dynamic random access memory (DRAM) such as synchronous DRAM (SDRAM)), a static memory 2506 (e.g., flash memory, static random access memory (SRAM)), and a data storage device 2516, which communicate with each other via a bus 2508.

Processing device 2502 represents one or more general-purpose processing devices such as a microprocessor, central processing unit, or the like. More particularly, the processing device 2502 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 2502 may also be one or more special-purpose processing devices such as an application specific integrated circuit (ASIC), a field programmable gate array (FPGA), a digital signal processor (DSP), network processor, or the like. The processing device 2502 is configured to execute instructions for performing the operations and steps discussed herein.

The computer system 2500 may further include a network interface device 2522. The computer system 2500 also may include a video display unit 2510 (e.g., a liquid crystal display (LCD) or a cathode ray tube (CRT)), an alphanumeric input device 2512 (e.g., a keyboard), a cursor control device 2514 (e.g., a mouse), and a signal generation device 2520 (e.g., a speaker). In one illustrative example, the video display unit 2510, the alphanumeric input device 2512, and the cursor control device 2514 may be combined into a single component or device (e.g., an LCD touch screen).

The data storage device 2516 may include a computer-readable medium 2524 on which the instructions 2526 (e.g., implementing character recognition engine 112 or training engine 151) embodying any one or more of the methodologies or functions described herein is stored. The instructions 2526 may also reside, completely or at least partially, within the main memory 2504 and/or within the processing device 2502 during execution thereof by the computer system 2500, the main memory 2504 and the processing device 2502 also constituting computer-readable media. The instructions 2526 may further be transmitted or received over a network via the network interface device 1122.

While the computer-readable storage medium 2524 is shown in the illustrative examples to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

Although the operations of the methods herein are shown and described in a particular order, the order of the operations of each method may be altered so that certain operations may be performed in an inverse order or so that certain operation may be performed, at least in part, concurrently with other operations. In certain implementations, instructions or sub-operations of distinct operations may be in an intermittent and/or alternating manner.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

In the above description, numerous details are set forth. It will be apparent, however, to one skilled in the art, that the aspects of the present disclosure may be practiced without these specific details. In some instances, well-known structures and devices are shown in block diagram form, rather than in detail, in order to avoid obscuring the present disclosure.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “receiving,” “determining,” “selecting,” “storing,” “setting,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear as set forth in the description. In addition, aspects of the present disclosure are not described with reference to any particular programming language. It will be appreciated that a variety of programming languages may be used to implement the teachings of the present disclosure as described herein.

Aspects of the present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.).

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

What is claimed is:

1. A method, comprising:
obtaining an image of text, wherein the text in the image includes one or more words in one or more sentences;
providing the image of the text as first input to a set of trained machine learning models;
obtaining one or more final outputs from the set of trained machine learning models; and
extracting, from the one or more final outputs, one or more predicted sentences from the text in the image, wherein each of the one or more predicted sentences includes a probable sequence of words.

2. The method of claim 1, wherein the set of trained machine learning models comprise:
first machine learning models trained to receive the image of the text as the first input and generate a first intermediate output for the first input,
a second machine learning model trained to receive a decoded first intermediate output as second input and generate a second intermediate output for the second input, and
a third machine learning model trained to receive the second intermediate output as third input and generate the one or more final outputs for the third input.

3. The method of claim 2, wherein:
the first intermediate output comprises a sequence of features of the text in the image, the features comprising information related to graphic elements representing one or more characters of the one or more words in the one or more sentences, and division points where the graphic elements are connected; and
the second intermediate output comprises one or more probable sequences of characters for each word selected from one or more sequences of characters for each word included in the decoded first intermediate output.

4. The method of claim 2, wherein the first machine learning models generate the first intermediate output by:
extracting the information related to the graphic elements by multiplying values of one or more filters by each pixel value at each position in the image, summing multiplications of the values to obtain a single number for each of the one or more filters, and applying an activation function to the single number for each of the one or more filters, wherein the information related to the graphic elements indicates whether a respective position in the image is associated with a graphic element and a Unicode code associated with a character represented by the graphic element; and
extracting the information related to the division points by multiplying values of one or more additional filters by each pixel value at each position in the image, summing multiplications of the values to obtain a single number for each of the one or more filters, and applying an activation function to the single number for each of the one or more filters, wherein the information related to the division points indicates whether the respective position includes a division point, a Unicode code of a character on the right of the division point, and a Unicode code of a character on the left of the division point.

5. The method of claim 2, wherein the decoded first intermediate output is produced by a decoder based on the first intermediate output, wherein producing the decoded first intermediate output comprises:
defining coordinates for a first position and a last position in the image where at least one foreground pixel is located;
obtaining a sequence of division points based at least on the coordinates for the first position and the last position;
identifying pairs of adjacent division points based on the sequence of division points;
determining a Unicode code for each character located between each of the pairs of adjacent division points; and
determining the one or more sequences of characters for each word based on the Unicode code for each character located between each of the pairs of adjacent division points.

6. The method of claim 2, wherein the first machine learning models comprise a first combination of a first convolutional neural network, a first recurrent neural network, and a first fully connected neural network trained to extract the information related to the graphic elements, and a second combination of a second convolutional neural network, a second recurrent neural network, and a second fully connected neural network trained to extract the information related to the division points.

7. The method of claim 2, wherein the first machine learning models comprise a combination of one or more convolutional neural networks, one or more recurrent neural networks, and one or more fully connected neural networks trained to extract the information related to the graphic elements and the information related to the division points.

8. The method of claim 3, wherein the second machine learning model comprises a character machine learning model trained to select a probable character for each position of each word from the one or more sequences of characters to generate the second intermediate output comprising the one or more probable sequences of characters for each word.

9. The method of claim 8, wherein selecting the probable character for each position of each word is based on a confidence indicator of each probable character at each position of each word, or based on the probable character being compatible with another probable character at another position in each word.

10. The method of claim 8, wherein the third machine learning model comprises a word machine learning model trained to select a probable word for each position in each of the one or more sentences from the one or more probable sequences of characters for each word to generate the one or more final outputs comprising one or more probable sequences of words for each of the one or more sentences.

11. The method of claim 10, wherein selecting the probable word for each position in each of the one or more sentences is based on a confidence indicator of each probable word at each position in each of the one or more sentences, or based on the probable word being compatible with another probable word at another position in each of the one or more sentences.

12. The method of claim 1, wherein at least one word comprises at least two characters that are merged.

13. The method of claim 1, wherein the set of machine learning models are trained with a training set comprising positive examples that include first texts, and negative examples that include second texts and error distribution, the second texts including alterations that simulate recognition errors of at least one of a character, a sequence of characters, or a sequence of words based on the error distribution.

14. A method for training a set of machine learning models to identify a probable sequence of words for each of the one or more sentences in an image of text, the method comprising:
generating training data for the set of machine learning models, wherein generating the training data comprises:
generating positive examples including first texts;
generating negative examples including second texts and error distribution, wherein the second texts include alterations that simulate at least one recognition error of one or more characters, one or more sequence of characters, or one or more sequence of words based on the error distribution;
generating an input training set comprising the positive examples and the negative examples; and
generating target outputs for the input training set, wherein the target outputs identify one or more predicted sentences, wherein each of the one or more predicted sentences includes a probable sequence of words; and
providing the training data to train the set of machine learning models on (i) the input training set and (ii) the target outputs.

15. The method of claim 14, wherein generating the negative examples further comprises:
dividing the positive examples into a first subset and a second subset;
recognizing text within the first subset;
determining the error distribution for recognized text within the first subset, wherein the error distribution includes one or more of incorrectly recognized characters, sequence of characters, or sequence of words; and
obtaining the negative examples by modifying the second subset based on the error distribution.

16. The method of claim 14, wherein the set of machine learning models are configured to process a new image of text and generate one or more outputs indicating the probable sequence of words for each of the one or more predicted sentences, wherein each word in each position of the probable sequence of words is selected based on context of a word in another position.

17. A non-transitory, computer-readable medium storing instructions that, when executed, cause a processing device to:
obtain an image of text, wherein the text in the image includes one or more words in one or more sentences;
provide the image of the text as first input to a set of trained machine learning models;
obtain one or more final outputs from the set of trained machine learning models; and
extract, from the one or more final outputs, one or more predicted sentences from the text in the image, wherein each of the one or more predicted sentences includes a probable sequence of words.

18. The computer-readable medium of claim 17, wherein the set of trained machine learning models comprise:
first machine learning models trained to receive the image of the text as the first input and generate a first intermediate output for the first input,
a second machine learning model trained to receive a decoded first intermediate output as second input and generate a second intermediate output for the second input, and
a third machine learning model trained to receive the second intermediate output as third input and generate the one or more final outputs for the third input.

19. The computer-readable medium of claim 18, wherein the first machine learning models comprise a combination of one or more convolutional neural network, one or more recurrent neural network, and one or more fully connected neural network trained to extract the information related to the graphic elements and the information related to the division points.

20. A system, comprising:
a memory device storing instructions;
a processing device coupled to the memory device, the processing device to execute the instructions to:
obtain an image of text, wherein the text in the image includes one or more words in one or more sentences;
provide the image of the text as first input to a set of trained machine learning models;
obtain one or more final outputs from the set of trained machine learning models; and
extract, from the one or more final outputs, one or more predicted sentences from the text in the image, wherein each of the one or more predicted sentences includes a probable sequence of words.
